(19) United States
(12) Patent Application Publication
(10) Pub. No.: US 2026/0129580 A1
(43) Pub. Date: May 7, 2026

(54) METHOD AND APPARATUS FOR TRANSMITTING AND RECEIVING INFORMATION THROUGH LOW POWER SIGNAL

(71) Applicant: ELECTRONICS AND TELECOMMUNICATIONS RESEARCH INSTITUTE, Daejeon (KR)

(72) Inventors: Junghoon LEE, Daejeon (KR); Ji Hyung KIM, Daejeon (KR); Cheulsoon KIM, Daejeon (KR); Sung-Hyun MOON, Daejeon (KR); Hoiyoon JUNG, Daejeon (KR)

(73) Assignee: ELECTRONICS AND TELECOMMUNICATIONS RESEARCH INSTITUTE, Daejeon (KR)

(21) Appl. No.: 19/338,991

(22) Filed: Sep. 24, 2025

(30) Foreign Application Priority Data
Sep. 26, 2024 (KR) 10-2024-0131079
May 8, 2025 (KR) 10-2025-0059760
Aug. 20, 2025 (KR) 10-2025-0116065
Sep. 22, 2025 (KR) 10-2025-0136638

(51) Int. Cl. H04W 52/02; H04W 68/02

(52) U.S. Cl. CPC H04W 52/0235; H04W 68/02

(57) ABSTRACT

Disclosed are methods and apparatuses for transmitting and receiving information through a low-power signal. A method of a terminal may comprise: receiving, from a base station, low-power wake-up signal (LP-WUS) monitoring occasion (LO) configuration information including a first offset and a second offset; determining, in a time domain, a frame before the first offset from a paging occasion (PO) as an LO frame in which an LO is configured; determining a time after the second offset from a start time of the LO frame as a start time of the LO; and performing a monitoring operation of an LP-WUS from the start time of the LO.

### CROSS-REFERENCE TO RELATED APPLICATIONS

This application claims priority to Korean Patent Applications No. 10-2024-0131079, filed on Sep. 26, 2024, No. 10-2025-0059760, filed on May 8, 2025, No. 10-2025-0116065, filed on Aug. 20, 2025, and No. 10-2025-0136638, filed on Sep. 22, 2025, with the Korean Intellectual Property Office (KIPO), the entire contents of which are hereby incorporated by reference.

### BACKGROUND

### 1. Technical Field

The present disclosure relates to a communication technique, and more particularly, to a technique for transmitting and receive information through a low-power signal.

### 2. Related Art

The communication system (e.g., a new radio (NR) communication system) using a higher frequency band (e.g., a frequency band of 6 GHz or above) than a frequency band (e.g., a frequency band of 6 GHz or below) of the long term evolution (LTE) communication system (or, LTE-A communication system) is being considered for processing of soaring wireless data. The NR system may support not only a frequency band of 6 GHz or below, but also a frequency band of 6 GHz or above, and may support various communication services and scenarios compared to the LTE system. In addition, requirements of the NR system may include enhanced Mobile BroadBand (eMBB), Ultra Reliable Low Latency Communication (URLLC), and Massive Machine Type Communication (mMTC).

Meanwhile, low-power operation may be supported in a communication system. A terminal supporting low-power operation may operate in an active state or a sleep state. The terminal in the sleep state may switch its operating state to the active state for paging monitoring. The terminal in the active state may perform paging monitoring. To reduce paging monitoring at the terminal, a paging early indication (PEI) may be introduced. The terminal supporting PEI may monitor downlink control information (DCI) (e.g., PEI DCI) that performs early paging indication sufficiently earlier than a preconfigured paging occasion (PO).

When the PEI DCI is received and a valid paging indication is identified in the PEI DCI, the terminal may determine that the terminal will soon be called, and may monitor the next PO. If necessary, the terminal may further perform an SSB measurement operation for synchronization and automatic gain control (AGC). It may be considered to use another signal that replaces the PEI DCI for power saving at the terminal. Even when another signal is used, an SSB measurement operation for synchronization and AGC may still be required before paging monitoring. Therefore, methods for configuring a transmission occasion of another signal in consideration of the SSB measurement operation are required.

### SUMMARY

The present disclosure for resolving the above-described problems is directed to providing a method and apparatus for transmitting and receive information through a low-power signal.

A method of a terminal, according to exemplary embodiments of the present disclosure, may comprise: receiving, from a base station, low-power wake-up signal (LP-WUS) monitoring occasion (LO) configuration information including a first offset and a second offset; determining, in a time domain, a frame before the first offset from a paging occasion (PO) as an LO frame in which an LO is configured; determining a time after the second offset from a start time of the LO frame as a start time of the LO; and performing a monitoring operation of an LP-WUS from the start time of the LO.

The first offset may be a frame-level offset configured in units of frames, and the second offset may be a slot-level offset configured in units of slots or a symbol-level offset configured in units of symbols.

Based on a configuration of a plurality of LOs associated with the PO, the LO configuration information may include the first offset for each of the plurality of LOs.

The LO configuration information may further include information indicating a number of beams used for LP-WUS transmission and information indicating a number of LP-WUS monitoring occasions (MOs) for each of the beams, the LO may include the LP-WUS MOs, and positions of the LP-WUS MOs within the LO may be determined based on the number of beams and the number of LP-WUS MOs.

The method may further comprise: performing a monitoring operation for reception of paging in one or more POs mapped to the LO, based on the LP-WUS detected by the monitoring operation indicating a wake-up of the terminal.

The LP-WUS may indicate one or more terminal subgroups that perform a monitoring operation for reception of paging in one or more POs mapped to the LO, and each of the one or more terminal subgroups may include one or more terminals.

The LP-WUS may support up to 32 codepoints to indicate the one or more terminal subgroups.

Based on the LO and the PO having a 1-to-1 mapping relation, the LP-WUS may indicate up to 31 terminal subgroups for one PO or an entire set of terminal subgroups for the one PO.

Based on the LO and the PO having a 1-to-2 mapping relation, the LP-WUS may indicate up to 15 terminal subgroups for each of two POs or an entire set of terminal subgroups for each of the two POs.

Based on the LO and the PO having a 1-to-4 mapping relation, the LP-WUS may indicate up to 7 terminal subgroups for each of four POs or an entire set of terminal subgroups for each of the four POs.

A method of a base station, according to exemplary embodiments of the present disclosure, may comprise: transmitting, to a terminal, low-power wake-up signal (LP-WUS) monitoring occasion (LO) configuration information including a first offset and a second offset; determining, in a time domain, a frame before the first offset from a paging occasion (PO) as an LO frame in which an LO is configured; determining a time after the second offset from a start time of the LO frame as a start time of the LO; and transmitting an LP-WUS to the terminal after the start time of the LO.

The first offset may be a frame-level offset configured in units of frames, and the second offset may be a slot-level offset configured in units of slots or a symbol-level offset configured in units of symbols.

Based on a configuration of a plurality of LOs associated with the PO, the LO configuration information may include the first offset for each of the plurality of LOs.

The LO configuration information may further include information indicating a number of beams used for LP-WUS transmission and information indicating a number of LP-WUS monitoring occasions (MOs) for each of the beams, the LO may include the LP-WUS MOs, and positions of the LP-WUS MOs within the LO may be determined based on the number of beams and the number of LP-WUS MOs.

The method may further comprise transmitting: paging to the terminal in one or more POs mapped to the LO.

The LP-WUS may indicate one or more terminal subgroups that perform a monitoring operation for reception of paging in one or more POs mapped to the LO, and each of the one or more terminal subgroups may include one or more terminals.

The LP-WUS may support up to 32 codepoints to indicate the one or more terminal subgroups.

Based on the LO and the PO having a 1-to-1 mapping relation, the LP-WUS may indicate up to 31 terminal subgroups for one PO or an entire set of terminal subgroups for the one PO.

Based on the LO and the PO having a 1-to-2 mapping relation, the LP-WUS may indicate up to 15 terminal subgroups for each of two POs or an entire set of terminal subgroups for each of the two POs.

Based on the LO and the PO having a 1-to-4 mapping relation, the LP-WUS may indicate up to 7 terminal subgroups for each of four POs or an entire set of terminal subgroups for each of the four POs.

According to the present disclosure, a base station can transmit low-power wake-up signal (LP-WUS) monitoring occasion (LO) configuration information including a first offset and a second offset to a terminal. A start time of an LO can be determined by the first offset and the second offset. Since the start time of the LO is clearly indicated by the first offset and the second offset, an ambiguity problem regarding the start time of the LO may not occur in the base station and the terminal. Therefore, transmission and reception operations of an LP-WUS between the base station and the terminal can be performed without a problem. In addition, the LP-WUS may indicate one or more terminal subgroups that perform paging monitoring. According to the LP-WUS, signaling overhead indicating a target of paging monitoring can be reduced. Therefore, performance of a communication system can be improved.

### BRIEF DESCRIPTION OF DRAWINGS

FIG. 1 is a conceptual diagram illustrating exemplary embodiments of a communication system.

FIG. 2 is a block diagram illustrating exemplary embodiments of a communication node constituting a communication system.

FIG. 3 is a conceptual diagram illustrating exemplary embodiments of a type 1 frame.

FIG. 4 is a conceptual diagram illustrating exemplary embodiments of a type 2 frame.

FIG. 5 is a conceptual diagram illustrating exemplary embodiments of a first transmission method of SSBs in a communication system.

FIG. 6 is a conceptual diagram illustrating exemplary embodiments of an SSB in a communication system.

FIG. 7 is a conceptual diagram illustrating exemplary embodiments of a second transmission method of SSBs in a communication system.

FIG. 8 is a conceptual diagram illustrating exemplary embodiments of SSB burst configuration.

FIG. 9 is a conceptual diagram illustrating exemplary embodiments of RMSI signaling for actual SSB transmission.

FIG. 10A is a conceptual diagram illustrating an RMSI CORESET mapping pattern #1 in a communication system.

FIG. 10B is a conceptual diagram illustrating an RMSI CORESET mapping pattern #2 in a communication system.

FIG. 10C is a conceptual diagram illustrating an RMSI CORESET mapping pattern #3 in a communication system.

FIG. 11A is a conceptual diagram illustrating a configuration of Type 0 CSS slots corresponding to an SSB index when M is ½.

FIG. 11B is a conceptual diagram illustrating a configuration of Type 0 CSS slots corresponding to an SSB index when M is 1.

FIG. 11C is a conceptual diagram illustrating a configuration of Type 0 CSS slots corresponding to an SSB index when M is 2.

FIG. 12A is a conceptual diagram illustrating exemplary embodiments of paging monitoring.

FIG. 12B is a conceptual diagram illustrating exemplary embodiments of PEI-based paging monitoring.

FIG. 13 is a conceptual diagram illustrating exemplary embodiments of an operation based on LP-WUS for paging monitoring indication.

FIG. 14 is a conceptual diagram illustrating exemplary embodiments of LO configuration for PEI through LP-WUS.

FIG. 15 is a conceptual diagram illustrating exemplary embodiments related to configuration of multiple LOs.

FIG. 16A and FIG. 16B are conceptual diagrams illustrating exemplary embodiments of DCP and LP-WUS operations.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may mean “at least one of A or B” or “at least one of combinations of one or more of A and B”. Also, in exemplary embodiments of the present disclosure, “one or more of A and B” may mean “one or more of A or B” or “one or more of combinations of one or more of A and B”.

In exemplary embodiments of the present disclosure, “(re) transmission” may mean “transmission”, “retransmission”, or “transmission and retransmission”, “(re) configuration” may mean “configuration”, “reconfiguration”, or “configuration and reconfiguration”, “(re) connection” may mean “connection”, “reconnection”, or “connection and reconnection”, and “(re) access” may mean “access”, “re-access”, or “access and re-access”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication system to which exemplary embodiments according to the present disclosure are applied will be described. The communication system may be the 4G communication system (e.g., Long-Term Evolution (LTE) communication system or LTE-A communication system), the 5G communication system (e.g., New Radio (NR) communication system), the sixth generation (6G) communication system, or the like. The 4G communication system may support communications in a frequency band of 6 GHz or below, and the 5G communication system may support communications in a frequency band of 6 GHz or above as well as the frequency band of 6 GHz or below. The communication system to which the exemplary embodiments according to the present disclosure are applied is not limited to the contents described below, and the exemplary embodiments according to the present disclosure may be applied to various communication systems. Here, the communication system may be used in the same sense as a communication network, ‘LTE’ may refer to ‘4G communication system’, ‘LTE communication system’, or ‘LTE-A communication system’, and ‘NR’ may refer to ‘5G communication system’ or ‘NR communication system’.

In exemplary embodiments, “an operation (e.g., transmission operation) is configured” may mean that “configuration information (e.g., information element(s) or parameter(s)) for the operation and/or information indicating to perform the operation is signaled”. “Information element(s) (e.g., parameter(s)) are configured” may mean that “corresponding information element(s) are signaled”. The signaling may be at least one of system information (SI) signaling (e.g., transmission of system information block (SIB) and/or master information block (MIB)), RRC signaling (e.g., transmission of RRC parameters and/or higher layer parameters), MAC control element (CE) signaling, or PHY signaling (e.g., transmission of downlink control information (DCI), uplink control information (UCI), and/or sidelink control information (SCI)).

In the present disclosure, a phrase including “when ˜” may be expressed as a phrase including “based on ˜” or “in response to ˜”. In other words, a phrase including “when ˜” may be interpreted as being the same as or similar to a phrase including “based on ˜” or “in response to ˜”.

In the present disclosure, a transmission time may mean a transmission start time or a transmission end time, and a reception time may mean a reception start time or a reception end time. A time point may refer to a time. In other words, ‘time point’ and ‘time’ may be used with the same meaning.

Hereinafter, even when a method (e.g., transmission or reception of a signal) performed at) a first communication node among communication nodes is described, a corresponding second communication node may perform a method (e.g., reception or transmission of the signal) corresponding to the method performed at the first communication node. That is, when an operation of a terminal is described, a base station corresponding to the terminal may perform an operation corresponding to the operation of the terminal. Conversely, when an operation of a base station is described, a terminal corresponding to the base station may perform an operation corresponding to the operation of the base station. In addition, when an operation of a first terminal is described, a second terminal corresponding to the first terminal may perform an operation corresponding to the operation of the first terminal. Conversely, when an operation of a second terminal is described, a first terminal corresponding to the second terminal may perform an operation corresponding to the operation of the second terminal.

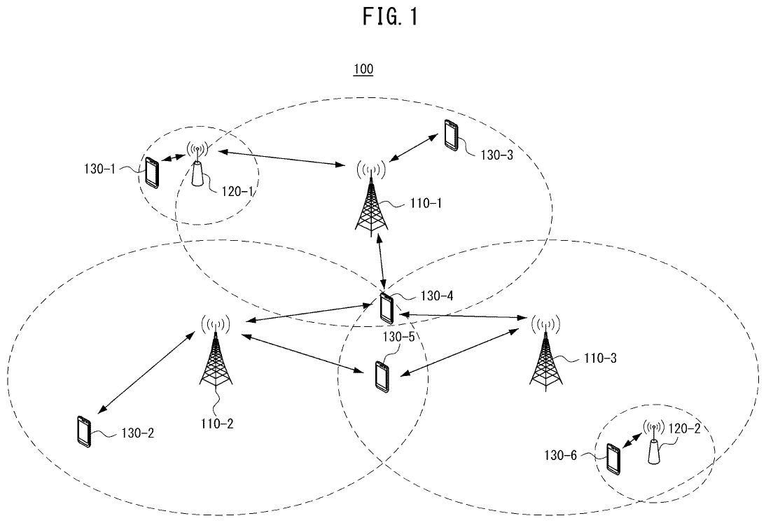

FIG. 1 is a conceptual diagram illustrating exemplary embodiments of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. In addition, the communication system 100 may further comprise a core network (e.g., a serving gateway (S-GW), a packet data network (PDN) gateway (P-GW), and a mobility management entity (MME)). When the communication system 100 is a 5G communication system (e.g., new radio (NR) system), the core network may include an access and mobility management function (AMF), a user plane function (UPF), a session management function (SMF), and the like.

The plurality of communication nodes 110 to 130 may support a communication protocol defined by the 3rd generation partnership project (3GPP) specifications (e.g., LTE communication protocol, LTE-A communication protocol, NR communication protocol, or the like). The plurality of communication nodes 110 to 130 may support code division multiple access (CDMA) technology, wideband CDMA (WCDMA) technology, time division multiple access (TDMA) technology, frequency division multiple access (FDMA) technology, orthogonal frequency division multiplexing (OFDM) technology, filtered OFDM technology, cyclic prefix OFDM (CP-OFDM) technology, discrete Fourier transform-spread-OFDM (DFT-s-OFDM) technology, orthogonal frequency division multiple access (OFDMA) technology, single carrier FDMA (SC-FDMA) technology, non-orthogonal multiple access (NOMA) technology, generalized frequency division multiplexing (GFDM) technology, filter band multi-carrier (FBMC) technology, universal filtered multi-carrier (UFMC) technology, space division multiple access (SDMA) technology, or the like. Each of the plurality of communication nodes may have the following structure.

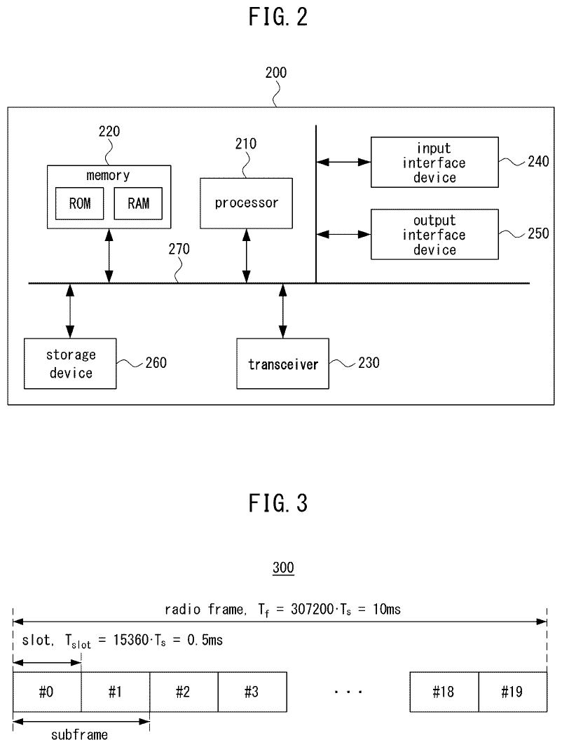

FIG. 2 is a block diagram illustrating exemplary embodiments of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B (NB), a evolved Node-B (eNB), a gNB, an advanced base station (ABS), a high reliability-base station (HR-BS), a base transceiver station (BTS), a radio base station, a radio transceiver, an access point, an access node, a radio access station (RAS), a mobile multihop relay-base station (MMR-BS), a relay station (RS), an advanced relay station (ARS), a high reliability-relay station (HR-RS), a home NodeB (HNB), a home eNodeB (HeNB), a road side unit (RSU), a radio remote head (RRH), a transmission point (TP), a transmission and reception point (TRP), or the like.

Each of the plurality of terminals 130-1, 130-2, 130-3, 130-4, 130-5, and 130-6 may refer to a user equipment (UE), a terminal equipment (TE), an advanced mobile station (AMS), a high reliability-mobile station (HR-MS), a terminal, an access terminal, a mobile terminal, a station, a subscriber station, a mobile station, a portable subscriber station, a node, a device, an on-board unit (OBU), or the like.

Each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support a multi-input multi-output (MIMO) transmission (e.g., a single-user MIMO (SU-MIMO), a multi-user MIMO (MU-MIMO), a massive MIMO, or the like), a coordinated multipoint (COMP) transmission, a carrier aggregation (CA) transmission, a transmission in unlicensed band, device-to-device (D2D) communication (or, proximity services (ProSe)), Internet of Things (IoT) communications, dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the COMP transmission manner, and the fourth terminal 130-4 may receive the signal from the first base station 110-1, the second base station 110-2, and the third base station 110-3 in the COMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Meanwhile, the communication system may support three types of frame structures. A type 1 frame structure may be applied to a frequency division duplex (FDD) communication system, a type 2 frame structure may be applied to a time division duplex (TDD) communication system, and a type 3 frame structure may be applied to an unlicensed band based communication system (e.g., a licensed assisted access (LAA) communication system).

FIG. 3 is a conceptual diagram illustrating exemplary embodiments of a type 1 frame.

Referring to FIG. 3, a radio frame 300 may comprise 10 subframes, and a subframe may comprise 2 slots. Thus, the radio frame 300 may comprise 20 slots (e.g., slot #0, slot #1, slot #2, slot #3, . . . , slot #18, and slot #19). The length T_{f} of the radio frame 300 may be 10 milliseconds (ms). The length of the subframe may be 1 ms, and the length Tₛₗₒₜ of a slot may be 0.5 ms. Here, Tₛ may indicate a sampling time, and may be 1/30,720,000s.

The slot may be composed of a plurality of OFDM symbols in the time domain, and may be composed of a plurality of resource blocks (RBs) in the frequency domain. The RB may be composed of a plurality of subcarriers in the frequency domain. The number of OFDM symbols constituting the slot may vary depending on configuration of a cyclic prefix (CP). The CP may be classified into a normal CP and an extended CP. If the normal CP is used, the slot may be composed of 7 OFDM symbols, in which case the subframe may be composed of 14 OFDM symbols. If the extended CP is used, the slot may be composed of 6 OFDM symbols, in which case the subframe may be composed of 12 OFDM symbols.

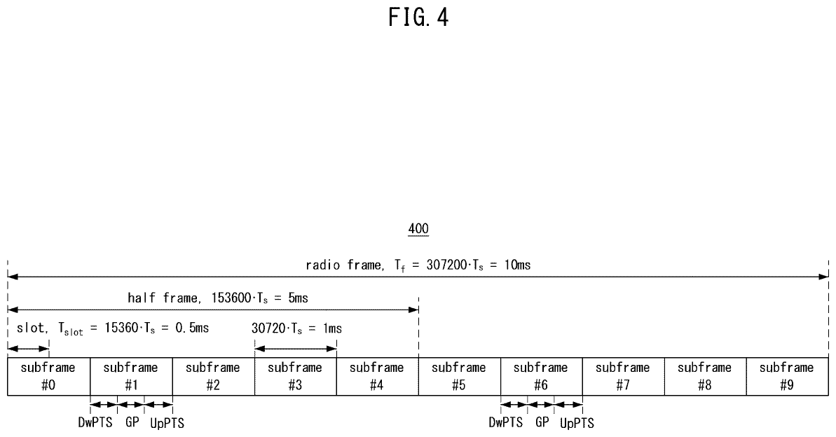

FIG. 4 is a conceptual diagram illustrating exemplary embodiments of a type 2 frame.

Referring to FIG. 4, a radio frame 400 may comprise two half frames, and a half frame may comprise 5 subframes. Thus, the radio frame 400 may comprise 10 subframes. The length T_{f} of the radio frame 400 may be 10 ms. The length of the half frame may be 5 ms. The length of the subframe may be 1 ms. Here, Tₛ may be 1/30,720,000s.

The radio frame 400 may include at least one downlink subframe, at least one uplink subframe, and a least one special subframe. Each of the downlink subframe and the uplink subframe may include two slots. The length Tₛₗₒₜ of a slot may be 0.5 ms. Among the subframes included in the radio frame 400, each of the subframe #1 and the subframe #6 may be a special subframe. For example, when a switching periodicity between downlink and uplink is 5 ms, the radio frame 400 may include 2 special subframes. Alternatively, the switching periodicity between downlink and uplink is 10 ms, the radio frame 400 may include one special subframe. The special subframe may include a downlink pilot time slot (DwPTS), a guard period (GP), and an uplink pilot time slot (UpPTS).

The downlink pilot time slot may be regarded as a downlink interval and may be used for cell search, time and frequency synchronization acquisition of the terminal, channel estimation, and the like. The guard period may be used for resolving interference problems of uplink data transmission caused by delay of downlink data reception. Also, the guard period may include a time required for switching from the downlink data reception operation to the uplink data transmission operation. The uplink pilot time slot may be used for uplink channel estimation, time and frequency synchronization acquisition, and the like. Transmission of a physical random access channel (PRACH) or a sounding reference signal (SRS) may be performed in the uplink pilot time slot.

The lengths of the downlink pilot time slot, the guard period, and the uplink pilot time slot included in the special subframe may be variably adjusted as needed. In addition, the number and position of each of the downlink subframe, the uplink subframe, and the special subframe included in the radio frame 400 may be changed as needed.

In the communication system, a transmission time interval (TTI) may be a basic time unit for transmitting coded data through a physical layer. A short TTI may be used to support low latency requirements in the communication system. The length of the short TTI may be less than 1 ms. The conventional TTI having a length of 1 ms may be referred to as a base TTI or a regular TTI. That is, the base TTI may be composed of one subframe. In order to support transmission on a base TTI basis, signals and channels may be configured on a subframe basis. For example, a cell-specific reference signal (CRS), a physical downlink control channel (PDCCH), a physical downlink shared channel (PDSCH), a physical uplink control channel (PUCCH), a physical uplink shared channel (PUSCH), and the like may exist in each subframe.

On the other hand, a synchronization signal (e.g., a primary synchronization signal (PSS) and a secondary synchronization signal (SSS)) may exist for every 5 subframes, and a physical broadcast channel (PBCH) may exist for every 10 subframes. Also, each radio frame may be identified by an SFN, and the SFN may be used for defining transmission of a signal (e.g., a paging signal, a reference signal for channel estimation, a signal for channel state information, etc.) longer than one radio frame. The periodicity of the SFN may be 1024.

In the LTE system, the PBCH may be a physical layer channel used for transmission of system information (e.g., master information block (MIB)). The PBCH may be transmitted every 10 subframes. That is, the transmission periodicity of the PBCH may be 10 ms, and the PBCH may be transmitted once in the radio frame. The same MIB may be transmitted during 4 consecutive radio frames, and after 4 consecutive radio frames, the MIB may be changed according to a situation of the LTE system. The transmission period for which the same MIB is transmitted may be referred to as a ‘PBCH TTI’, and the PBCH TTI may be 40 ms. That is, the MIB may be changed for each PBCH TTI.

The MIB may be composed of 40 bits. Among the 40 bits constituting the MIB, 3 bits may be used to indicate a system band, 3 bits may be used to indicate physical hybrid automatic repeat request (ARQ) indicator channel (PHICH) related information, 8 bits may be used to indicate an SFN, 10 bits may be configured as reserved bits, and 16 bits may be used for a cyclic redundancy check (CRC).

The SFN for identifying the radio frame may be composed of a total of 10 bits (B9 to B0), and the most significant bits (MSBs) 8 bits (B9 to B2) among the 10 bits may be indicated by the PBCH (i.e., MIB). The MSBs 8 bits (B9 to B2) of the SFN indicated by the PBCH (i.e., MIB) may be identical during 4 consecutive radio frames (i.e., PBCH TTI). The least significant bits (LSBs) 2 bits (B1 to B0) of the SFN may be changed during 4 consecutive radio frames (i.e., PBCH TTI), and may not be explicitly indicated by the PBCH (i.e., MIB). The LSBs (2 bits (B1 to B0)) of the SFN may be implicitly indicated by a scrambling sequence of the PBCH (hereinafter referred to as ‘PBCH scrambling sequence’).

A gold sequence generated by being initialized by a cell ID may be used as the PBCH scrambling sequence, and the PBCH scrambling sequence may be initialized for each four consecutive radio frames (e.g., each PBCH TTI) based on an operation of ‘mod (SFN, 4)’. The PBCH transmitted in a radio frame corresponding to an SFN with LSBs 2 bits (B1 to B0) set to ‘00’ may be scrambled by the gold sequence generated by being initialized by the cell ID. Thereafter, the gold sequences generated according to the operation of ‘mod (SFN, 4)’ may be used to scramble the PBCH transmitted in the radio frames corresponding to SFNs with LSBs 2 bits (B1 to B0) set to ‘01’, ‘10’, and ‘11’.

Accordingly, the terminal having acquired the cell ID in the initial cell search process may identify the value of the LSBs 2 bits (B1 to B0) of the SFN (e.g., ‘00’, ‘01’, ‘10’, or ‘11’) based on the PBCH scramble sequence obtained in the decoding process for the PBCH (i.e., MIB). The terminal may use the LSBs 2 bits (B1 to B0) of the SFN obtained based on the PBCH scrambling sequence and the MSBs 8 bits (B9 to B2) of the SFN indicated by the PBCH (i.e., MIB) so as to identify the SFN (i.e., the entire bits B9 to B0 of the SFN).

On the other hand, the communication system may support not only a high transmission rate but also technical requirements for various service scenarios. For example, the communication system may support an enhanced mobile broadband (eMBB) service, an ultra-reliable low-latency communication (URLLC) service, a massive machine type communication (mMTC) service, and the like.

The subcarrier spacing of the communication system (e.g., OFDM-based communication system) may be determined based on a carrier frequency offset (CFO) and the like. The CFO may be generated by a Doppler effect, a phase drift, or the like, and may increase in proportion to an operation frequency. Therefore, in order to prevent the performance degradation of the communication system due to the CFO, the subcarrier spacing may increase in proportion to the operation frequency. On the other hand, as the subcarrier spacing increases, a CP overhead may increase. Therefore, the subcarrier spacing may be configured based on a channel characteristic, a radio frequency (RF) characteristic, etc. according to a frequency band.

The communication system may support numerologies defined in Table 1 below.

TABLE 1

| Numerology (μ) | 0 | 1 | 2 | 3 | 4 | 5 |
|---|---|---|---|---|---|---|
| Subcarrier | 15 kHz | 30 kHz | 60 kHz | 120 kHz | 240 kHz | 480 kHz |
| spacing | | | | | | |
| OFDM symbol | 66.7 | 33.3 | 16.7 | 8.3 | 4.2 | 2.1 |
| length [us] | | | | | | |
| CP length [us] | 4.76 | 2.38 | 1.19 | 0.60 | 0.30 | 0.15 |
| Number of | 14 | 28 | 56 | 112 | 224 | 448 |
| OFDM symbols | | | | | | |
| within 1 ms | | | | | | |

For example, the subcarrier spacing of the communication system may be configured to 15 kHz, 30 kHz, 60 kHz, or 120 kHz. The subcarrier spacing of the LTE system may be 15 kHz, and the subcarrier spacing of the NR system may be 1, 2, 4, or 8 times the conventional subcarrier spacing of 15 kHz. If the subcarrier spacing increases by exponentiation units of 2 of the conventional subcarrier spacing, the frame structure can be easily designed.

The communication system may support FR1 as well as FR2. The FR2 may be classified into FR2-1 and FR2-2. The FR1 may be a frequency band of 6 GHz or below, the FR2-1 may be a frequency band of 24.25 to 52.6, and the FR2-2 may be a frequency band of 52.6 to 71 GHz. In an exemplary embodiment, the FR2 may be the FR2-1, the FR2-1, or a frequency band including the FR2-1 and FR2-2. In each of the FR1, FR2-1, and FR2-2, subcarrier spacings available for data transmission may be defined as shown in Table 2 below. In each of the FR1, the FR2-1, and the FR2-2, SCSs available for synchronization signal block (SSB) transmission may be defined as shown in Table 3 below. In each of the FR1, the FR2-1, and the FR2-2, SCSs available for RACH transmission (e.g., Msg1 or Msg-A) may be defined as shown in Table 4 below.

TABLE 2
data

| FR1 | FR2-1 | FR2-2 |
|---|---|---|
| 15 kHz, 30 kHz, | 60 kHz, 120 kHz | 120 kHz, 480 kHz, |
| 60 kHz (optional) | | 960 kHz |

TABLE 3
SSB

| FR1 | FR2-1 | FR2-2 |
|---|---|---|
| 15 kHz, 30 kHz | 120 kHz, 240 kHz | 120 kHz, 480 kHz, |
| | | 960 kHz |

TABLE 4
RACH

| FR1 | FR2-1 | FR2-2 |
|---|---|---|
| 1.25 kHz, 5 kHz, | 60 kHz, 120 kHz | 120 kHz, 480 kHz, |
| 15 kHz, 30 kHz | | 960 kHz |

The communication system may support a wide frequency band (e.g., several hundred MHz to tens of GHz). Since the diffraction characteristic and the reflection characteristic of the radio wave are poor in a high frequency band, a propagation loss (e.g., path loss, reflection loss, and the like) in a high frequency band may be larger than a propagation loss in a low frequency band. Therefore, a cell coverage of a communication system supporting a high frequency band may be smaller than a cell coverage of a communication system supporting a low frequency band. In order to solve such the problem, a beamforming scheme based on a plurality of antenna elements may be used to increase the cell coverage in the communication system supporting a high frequency band.

The beamforming scheme may include a digital beamforming scheme, an analog beamforming scheme, a hybrid beamforming scheme, and the like. In the communication system using the digital beamforming scheme, a beamforming gain may be obtained using a plurality of RF paths based on a digital precoder or a codebook. In the communication system using the analog beamforming scheme, a beamforming gain may be obtained using analog RF devices (e.g., phase shifter, power amplifier (PA), variable gain amplifier (VGA), and the like) and an antenna array.

Because of the need for expensive digital to analog converters (DACs) or analog to digital converters (ADCs) for digital beamforming schemes and transceiver units corresponding to the number of antenna elements, the complexity of antenna implementation may be increased to increase the beamforming gain. In case of the communication system using the analog beamforming scheme, since a plurality of antenna elements are connected to one transceiver unit through phase shifters, the complexity of the antenna implementation may not increase greatly even if the beamforming gain is increased. However, the beamforming performance of the communication system using the analog beamforming scheme may be lower than the beamforming performance of the communication system using the digital beamforming scheme. Further, in the communication system using the analog beamforming scheme, since the phase shifter is adjusted in the time domain, frequency resources may not be efficiently used. Therefore, a hybrid beamforming scheme, which is a combination of the digital scheme and the analog scheme, may be used.

When the cell coverage is increased by the use of the beamforming scheme, common control channels and common signals (e.g., reference signal and synchronization signal) for all terminals belonging to the cell coverage as well as control channels and data channels for each terminal may also be transmitted based on the beamforming scheme. In this case, the common control channels and the common signals for all terminals belonging to the cell coverage may be transmitted based on a beam sweeping scheme.

In addition, in the NR system, a synchronization signal/physical broadcast channel (SS/PBCH) block may also be transmitted in a beam sweeping scheme. The SS/PBCH block may be composed of a PSS, an SSS, a PBCH, and the like. In the SS/PBCH block, the PSS, the SSS, and the PBCH may be configured in a time division multiplexing (TDM) manner. The SS/PBCH block may be referred also to as an ‘SS block (SSB)’. One SS/PBCH block may be transmitted using N consecutive OFDM symbols. Here, N may be an integer equal to or greater than 4. The base station may periodically transmit the SS/PBCH block, and the terminal may acquire frequency/time synchronization, a cell ID, system information, and the like based on the SS/PBCH block received from the base station. The SS/PBCH block may be transmitted as follows.

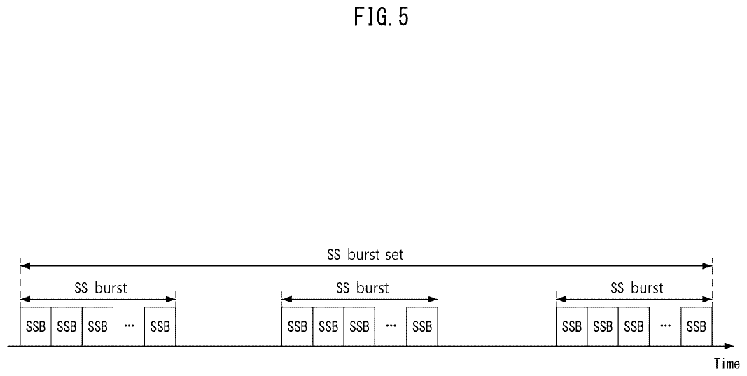

FIG. 5 is a conceptual diagram illustrating exemplary embodiments of a first transmission method of SSBs in a communication system.

Referring to FIG. 5, one or more SSBs (SS blocks) may be transmitted in a beam sweeping scheme within an SS burst set. Up to L SSBs may be transmitted within one SS burst set. L may be an integer equal to or greater than 2, and may be defined in the 3GPP standard. Depending on a region of a system frequency, L may vary. Within the SS burst set, the SSBs may be located consecutively or distributedly. The consecutive SSBs may be referred to as an ‘SS/PBCH block burst’ or ‘SSB burst’. The SS burst set may be repeated periodically, and system information (e.g., MIB) transmitted through the PBCHs of the SSBs within the SS burst set may be the same. An index of the SSB, an index of the SSB burst, an index of an OFDM symbol, an index of a slot, and the like may be indicated explicitly or implicitly by the PBCH.

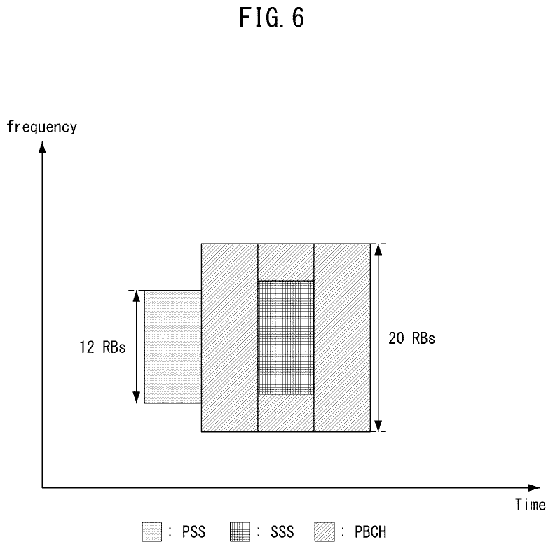

FIG. 6 is a conceptual diagram illustrating exemplary embodiments of an SSB in a communication system.

Referring to FIG. 6, signals and a channel are arranged within one SSB in the order of ‘PSS→PBCH→SSS→PBCH’. The PSS, SSS, and PBCH within the SS/PBCH block may be configured in a TDM scheme. In a symbol where the SSS is located, the PBCH may be located in frequency resources above the SSS and frequency resources below the SSS. When the maximum number of SSBs is 8 in the sub-6 GHz frequency band, an SSB index may be identified based on a demodulation reference signal used for demodulating the PBCH (hereinafter, referred to as ‘PBCH DMRS’). When the maximum number of SSBs is 64 in the above-6 GHz frequency band, LSB 3 bits of 6 bits representing the SSB index may be identified based on the PBCH DMRS, and the remaining MSB 3 bits may be identified based on a payload of the PBCH.

The maximum system bandwidth that can be supported in the NR system may be 400 MHz. The size of the maximum bandwidth that can be supported by the terminal may vary depending on the capability of the terminal. Therefore, the terminal may perform an initial access procedure (e.g., initial connection procedure) by using some of the system bandwidth of the NR system supporting a wide band. In order to support access procedures of terminals supporting various sizes of bandwidths, SSBs may be multiplexed in the frequency domain within the system bandwidth of the NR system supporting a wide band. In this case, the SSBs may be transmitted as follows.

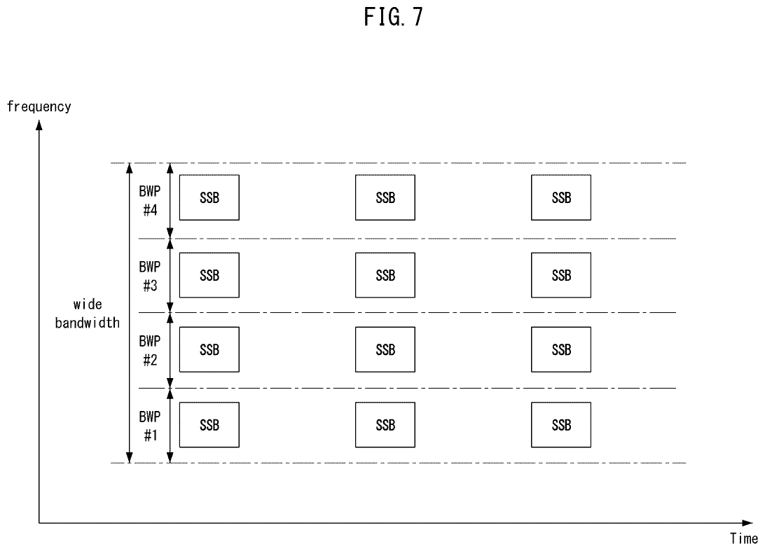

FIG. 7 is a conceptual diagram illustrating exemplary embodiments of a second transmission method of SSBs in a communication system.

Referring to FIG. 7, a wideband component carrier (CC) may include a plurality of bandwidth parts (BWPs). For example, the wideband CC may include 4 BWPs. The base station may transmit SSBs in the respective BWPs #0 to #3 belonging to the wideband CC. The terminal may receive the SSB(s) from one or more BWPs of the BWPs #0 to #3, and may perform an initial access procedure using the received SSB(s).

After detecting the SSB, the terminal may acquire system information (e.g., remaining minimum system information (RMSI)), and may perform a cell access procedure based on the system information. The RMSI may be transmitted on a PDSCH scheduled by a PDCCH. Configuration information of a control resource set (CORESET) in which the PDCCH including scheduling information of the PDSCH through which the RMSI is transmitted may be transmitted on a PBCH within the SSB. A plurality of SSBs may be transmitted in the entire system band, and one or more SSBs among the plurality of SSBs may be SSB(s) associated with the RMSI. The remaining SSBs may not be associated with the RMSI. The SSB associated with the RMSI may be defined as a ‘cell-defining (CD)-SSB’. The terminal may perform a cell search procedure and an initial access procedure by using the CD-SSB. The SSB not associated with the RMSI may be used for a synchronization procedure and/or a measurement procedure in the corresponding BWP. The SSB not associated with the RMSI may be defined as a non-cell-defining SSB. The non-cell-defining SSB may be referred to as a non-cell-defining (NCD)-SSB. The BWP(s) through which the SSBs are transmitted may be limited to one or more BWPs within a wide bandwidth.

The positions at which the SSBs are transmitted in the time domain may be defined differently according to an SCS and a value of L. In exemplary embodiments, the SCS may mean a subcarrier spacing (e.g., a subcarrier size). The SSB may be transmitted in some symbols within one slot, and a short UL transmission (e.g., uplink control information (UCI) transmission) may be performed in the remaining symbols not used for the SSB transmission within one slot. When the SSB is transmitted in radio resources to which a large SCS (e.g., 120 kHz SCS or 240 kHz SCS) is applied, a gap may be configured in the middle of consecutive slots including the SSB so that a long UL transmission (e.g., transmission of URLLC traffic) can be performed at least every 1 ms.

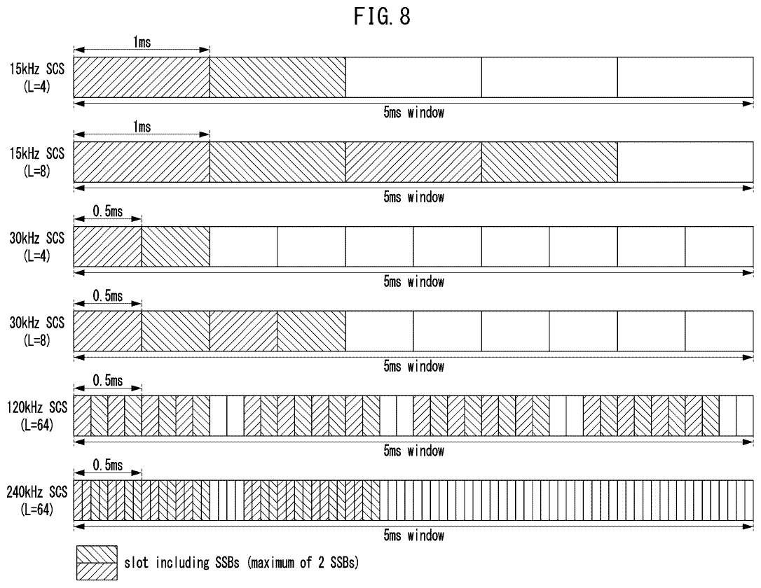

FIG. 8 is a conceptual diagram illustrating exemplary embodiments of SSB burst configuration.

Referring to FIG. 8, in a transmission procedure of SSBs (e.g., SSB burst) in radio resources to which a 120 kHz SCS is applied, the base station may transmit SSBs in 8 consecutive slots. In a transmission procedure of SSBs in radio resources to which s 240 kHz SCS is applied, the base station may transmit SSBs in 16 consecutive slots. In the radio resources to which the 120 kHz SCS or 240 kHz SCS is applied, a gap for UL transmission may be configured.

Within an SSB burst set (e.g., SS burst set), up to L transmittable positions for SSB transmissions may be defined. A value of L may vary depending on a frequency range. For example, up to 4 SSB transmissions may be possible in a 0-3 GHz frequency band of FR1, up to 8 SSB transmissions may be possible in a frequency band above 3 GHz of FR1, and up to 64 SSB transmissions may be possible in FR2. The base station may actually transmit SSBs at all L positions depending on an environment (e.g., an environment of the communication system). Alternatively, the base station may actually transmit SSBs at some of the L positions.

When the terminal receives data at a position where SSB transmission is possible, the terminal may determine whether to perform rate matching for the data based on whether an SSB is actually transmitted at the position. The base station may transmit information on the positions at which actual SSB transmissions are performed to the terminal through RMSI and/or UE-specific RRC signaling. The terminal may identify the information on the positions at which actual SSB transmissions are performed through the RMSI and/or UE-specific RRC signaling of the base station. The actual SSB transmission may indicate that the SSB is actually transmitted. The information on the positions at which actual SSB transmissions are performed may be included in the RMSI. When L is 4, a 4-bit bitmap may be used to indicate the positions at which actual SSB transmissions are performed, and when L is 8, an 8-bit bitmap may be used to indicate the positions at which actual SSB transmissions are performed. A 4-bit bitmap may refer to a bitmap having a size of 4 bits. An 8-bit bitmap may refer to a bitmap having a size of 8 bits. A bit set to a first value (e.g., 0) in the bitmap may indicate that the SSB is not transmitted at the position corresponding to the bit. A bit set to a second value (e.g., 1) in the bitmap may indicate that the SSB is transmitted at the position corresponding to the bit.

When L is 64, information on 64 positions may be delivered in a compressed form of 16 bits. The 64 positions may be divided into 8 groups of 8 positions each, and an 8-bit bitmap for the 8 groups may be configured, and an 8-bit bitmap for the 8 positions belonging to each of the 8 groups may be configured. The information on the 64 positions may be represented by 16 bits based on two 8-bit bitmaps. A transmission pattern of SSBs within the groups may be identical.

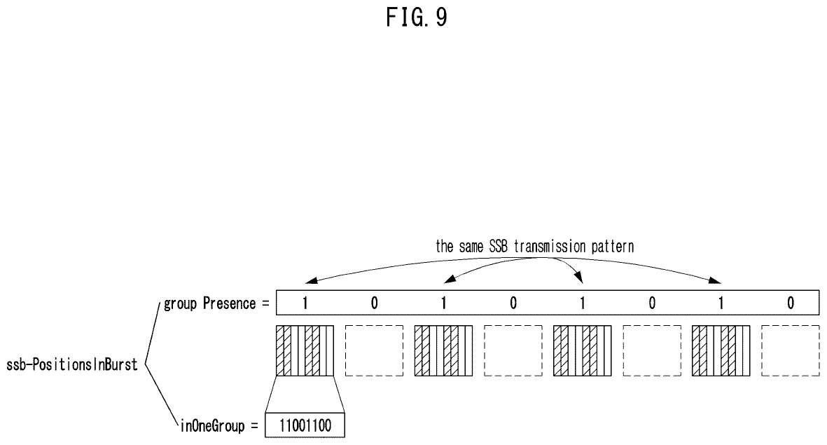

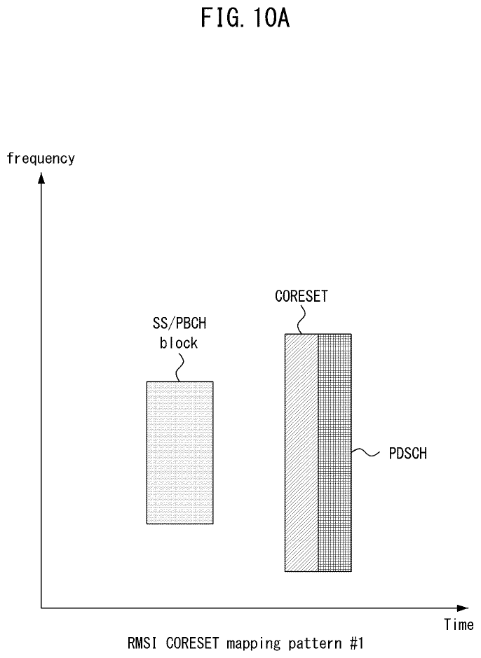

FIG. 9 is a conceptual diagram illustrating exemplary embodiments of RMSI signaling for actual SSB transmission.

Referring to FIG. 9, the base station may inform the terminal of position(s) of actual SSB transmissions through the RMSI. ssb-PositionsInBurst included in the RMSI may indicate the position(s) of the actual SSB transmissions. ssb-PositionsInBurst may include inOneGroup and/or groupPresence. Each of inOneGroup and groupPresence may have a size of 8 bits. inOneGroup may be an 8-bit bitmap and may indicate whether SSB(s) are transmitted within a group. groupPresence may be an 8-bit bitmap and may indicate whether the SSB(s) are transmitted per group. In other words, groupPresence may indicate the group(s) in which SSB(s) are transmitted.

groupPresence may indicate the group(s) in which the SSB(s) are transmitted, and the group(s) indicated by groupPresence may have the same SSB transmission pattern (e.g., same SSB transmission positions) as indicated by inOneGroup. Based on the above-described method, information on the 64 positions may be indicated by 16 bits. The signaling overhead for indicating the positions at which SSB transmissions are possible may be reduced. However, the SSB transmission positions indicated by the above-described method may differ from the positions of actual SSB transmissions.

For example, in the exemplary embodiment of FIG. 9, when the communication system (e.g., base station) operates the SSB transmission pattern of the first group and the SSB transmission pattern of the third group differently, different SSB transmission patterns may not be indicated according to the above-described method (e.g., the method based on inOneGroup and groupPresence). To solve the above-described problem, the base station may transmit a 64-bit bitmap indicating the positions of actual SSB transmissions to the terminal through UE-specific RRC signaling. When the positions of actual SSB transmissions are delivered through UE-specific RRC signaling, a full bitmap may be delivered to the terminal regardless of the value of L. The full bitmap may be a 64-bit bitmap.

The RMSI may be obtained by performing an operation to obtain configuration information of a CORESET from the SSB (e.g., PBCH), an operation of detecting a PDCCH based on the configuration information of the CORESET, an operation to obtain scheduling information of a PDSCH from the PDCCH, and an operation to receive the RMSI on the PDSCH. A transmission resource of the PDCCH may be configured by the configuration information of the CORESET. A mapping patter of the RMSI CORESET pattern may be defined as follows. The RMSI CORESET may be a CORESET used for transmission and reception of the RMSI.

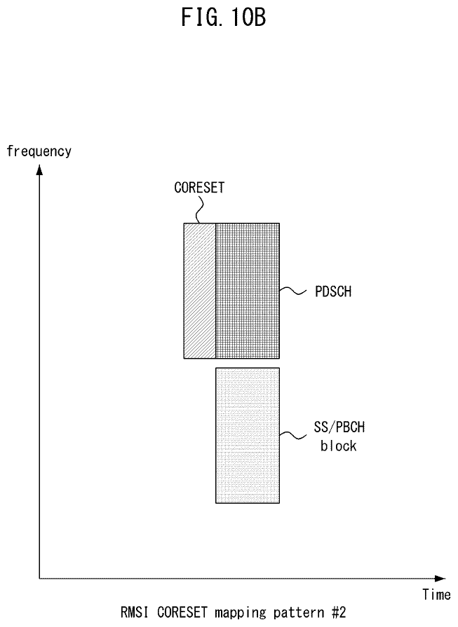

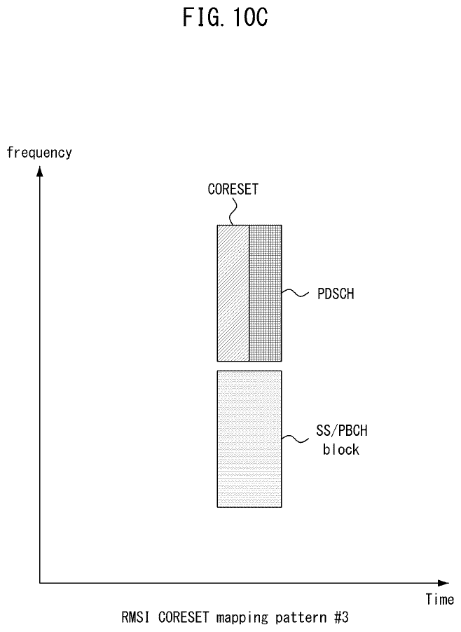

FIG. 10A is a conceptual diagram illustrating an RMSI CORESET mapping pattern #1 in a communication system, FIG. 10B is a conceptual diagram illustrating an RMSI CORESET mapping pattern #2 in a communication system, and FIG. 10C is a conceptual diagram illustrating an RMSI CORESET mapping pattern #3 in a communication system.

Referring to FIGS. 10A to 10C, one RMSI CORESET mapping pattern among the RMSI CORESET mapping patterns #1 to #3 may be used, and a detailed configuration according to the one RMSI CORESET mapping pattern may be determined. In the RMSI CORESET mapping pattern #1, the SS/PBCH block, the CORESET (i.e., RMSI CORESET), and the PDSCH (i.e., RMSI PDSCH) may be configured in a TDM scheme. The RMSI PDSCH may mean the PDSCH through which the RMSI is transmitted. In the RMSI CORESET mapping pattern #2, the CORESET (i.e., RMSI CORESET) and the PDSCH (i.e., RMSI PDSCH) may be configured in a TDM scheme, and the PDSCH (i.e., RMSI PDSCH) and the SS/PBCH block may be configured in a frequency division multiplexing (FDM) scheme. In the RMSI CORESET mapping pattern #3, the CORESET (i.e., RMSI CORESET) and the PDSCH (i.e., RMSI PDSCH) may be configured in a TDM scheme, and the CORESET (i.e., RMSI CORESET) and the PDSCH (i.e., RMSI PDSCH) may be multiplexed with the SS/PBCH block in a FDM scheme.

In the frequency band of 6 GHz or below, only the RMSI CORESET mapping pattern #1 may be used. In the frequency band of 6 GHz or above, all of the RMSI CORESET mapping patterns #1, #2, and #3 may be used. The numerology of the SS/PBCH block may be different from that of the RMSI CORESET and the RMSI PDSCH. Here, the numerology may be a subcarrier spacing. In the RMSI CORESET mapping pattern #1, a combination of all numerologies may be used. In the RMSI CORESET mapping pattern #2, a combination of numerologies (120 kHz, 60 kHz) or (240 kHz, 120 kHz) may be used for the SS/PBCH block and the RMSI CORESET/PDSCH. In the RMSI CORESET mapping pattern #3, a combination of numerologies (120 kHz, 120 kHz) may be used for the SS/PBCH block and the RMSI CORESET/PDSCH.

One RMSI CORESET mapping pattern may be selected from the RMSI CORESET mapping patterns #1 to #3 according to the combination of the numerology of the SS/PBCH block and the numerology of the RMSI CORESET/PDSCH. The configuration information of the RMSI CORESET may include Table A and Table B. Table A may represent the number of resource blocks (RBs) of the RMSI CORESET, the number of symbols of the RMSI CORESET, and an offset between an RB (e.g., starting RB or ending RB) of the SS/PBCH block and an RB (e.g., starting RB or ending RB) of the RMSI CORESET. Table B may represent the number of search space sets per slot, an offset of the RMSI CORESET, and an OFDM symbol index in each of the RMSI CORESET mapping patterns. Table B may represent information for configuring a monitoring occasion of the RMSI PDCCH. Each of Table A and Table B may be composed of a plurality of sub-tables. For example, Table A may include sub-tables 13-1 to 13-8 defined in the technical specification (TS) 38.213, and Table B may include sub-tables 13-9 to 13-13 defined in the TS 38.213. The size of each of Table A and Table B may be 4 bits.

Among three RMSI CORESET mapping patterns, in the RMSI CORESET mapping pattern #1, the terminal may perform monitoring for a Type 0 common search space (CSS) in two consecutive slots. A position no of a start slot for Type 0 CSS monitoring may be determined based on Equation 1 below.

$${n}_{0} = ( O \cdot {2}^{μ} + ⌊ i \cdot M ⌋ ) mod {N}_{slot}^{frame , μ} \qquad [ Equation 1 ]$$

In Equation 1, μ may indicate a subcarrier spacing (SCS). In other words, μ may indicate a subcarrier size. When the SCS is 15 kHz, μ may be 0. When the SCS is 30 kHz, μ may be 1. When the SCS is 60 kHz, μ may be 2. When the SCS is 120 kHz, μ may be 3. i may indicate an SSB index. In unlicensed band operations, an SSB candidate index I may be used instead of the SSB index i in Equation 1.

$${N}_{slot}^{frame , μ}$$

may indicate the number of slots having the SCS corresponding to the value μ within a radio frame. O and M may be configurable parameters for scheduling flexibility of the base station. In the procedure for determining the position of the Type 0 CSS slot, O may be used to indicate an offset between an SSB and the Type 0 CSS slot. In the monitoring procedure for two consecutive slots, M may be used to determine whether there is overlap between Type 0 CSS slots (e.g., Type 0 CSS monitoring slots). A Type 0 CSS slot may indicate a slot in which a Type 0 CSS is configured. M may be set to one of ½, 1, or 2. The degree of overlap between the two Type 0 CSS slots corresponding to one SSB index may be differently configured according to the value of M.

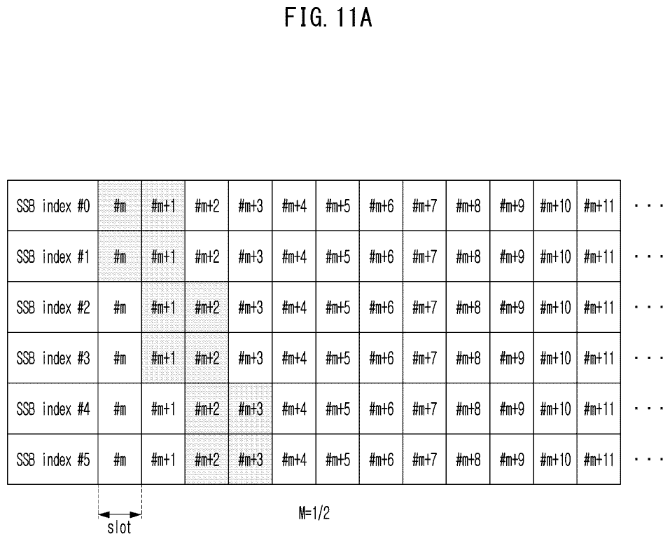

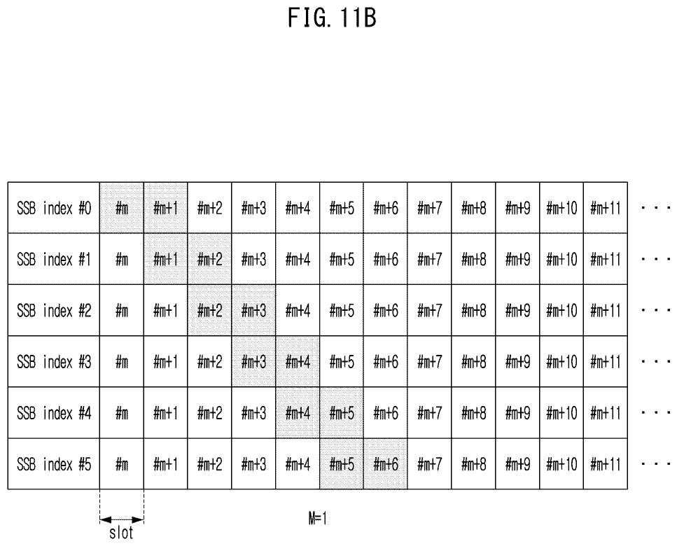

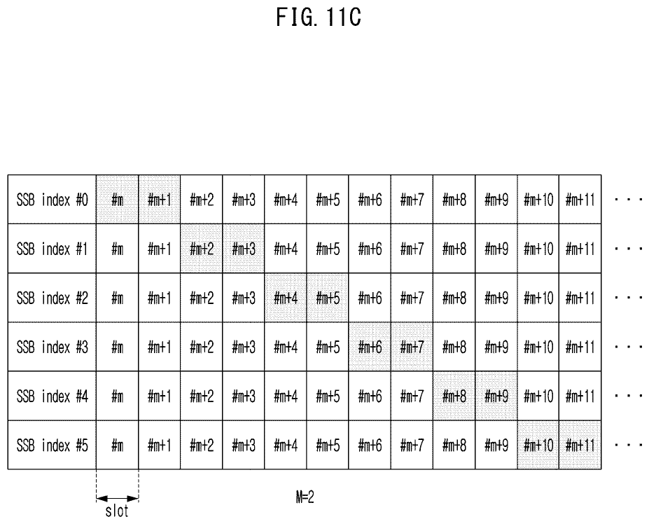

FIG. 11A is a conceptual diagram illustrating a configuration of Type 0 CSS slots corresponding to an SSB index when M is ½.

Referring to FIG. 11A, when M is ½, Type 0 CSS slots (e.g., slot #m, slot #m+1) corresponding to two SSB indexes (e.g., SSB index #0 and SSB index #1) may be configured to completely overlap. Type 0 CSS slots (e.g., slot #m+1, slot #m+2) corresponding to the next two SSB indexes (e.g., SSB index #2 and SSB index #3) may be configured to overlap with the previous Type 0 CSS slots (e.g., slot #m, slot #m+1) by only one slot (e.g., slot #m+1).

FIG. 11B is a conceptual diagram illustrating a configuration of Type 0 CSS slots corresponding to an SSB index when M is 1.

Referring to FIG. 11B, when M is 1, only the first slot among two consecutive slots (e.g., two consecutive Type 0 CSS slots) corresponding to each SSB index may be configured to overlap with the second slot among two slots corresponding to the previous SSB index.

FIG. 11C is a conceptual diagram illustrating a configuration of Type 0 CSS slots corresponding to an SSB index when M is 2.

Referring to FIG. 11C, when M is 2, two consecutive slots (e.g., two consecutive Type 0 CSS slots) corresponding to each SSB index may be configured not to overlap with two slots corresponding to the previous SSB index.

In the NR system, a PDSCH may be mapped to the time domain according to a PDSCH mapping type A or a PDSCH mapping type B. The PDSCH mapping types A and B may be defined as Table 5 below.

TABLE 5

| PDSCH | | | | | | |
|---|---|---|---|---|---|---|
| mapping | Normal CP | | | Extended CP | | |
| type | S | L | S + L | S | L | S + L |
| Type A | {0, 1, 2, 3} | (3, . . . , 14} | {3, . . . , 14} | {0, 1, 2, 3} | {3, . . . , 12} | {3, . . . , 12} |
| | (Note 1) | | | (Note 1) | | |
| Type B | {0, . . . , 12} | {2, 4, 7} | {2, . . . , 14} | {0, . . . , 10} | {2, 4, 6} | {2, . . . , 12} |

Note 1:
S = 3 is applicable only if dmrs-TypeA-Position = 3

The type A (i.e., PDSCH mapping type A) may be slot-based transmission. When the type A is used, a position of a start symbol of a PDSCH may be configured to one of {0, 1, 2, 3}. When the type A and a normal CP are used, the number of symbols constituting the PDSCH (e.g., the duration of the PDSCH) may be configured to one of 3 to 14 within a range not exceeding a slot boundary. The type B (i.e., PDSCH mapping type B) may be non-slot-based transmission. When the type B is used, a position of a start symbol of a PDSCH may be configured to one of 0 to 12. When the type B and the normal CP are used, the number of symbols constituting the PDSCH (e.g., the duration of the PDSCH) may be configured to one of {2, 4, 7} within a range not exceeding a slot boundary. A DMRS (hereinafter, referred to as ‘PDSCH DMRS’) for demodulation of the PDSCH (e.g., data) may be determined by the PDSCH mapping type (e.g., type A or type B) and an ID indicating the length. The ID may be defined differently according to the PDSCH mapping type.

Meanwhile, in the NR standardization meeting, new features (e.g., UE power saving) are being discussed. To reduce power consumption of a terminal, a long cell-discontinuous reception (C-DRX) may be configured for the terminal. The terminal may monitor a PDCCH (e.g., DCI format 2_6) before a DRX on-duration (e.g., a period of a DRX on-duration). When information included in the PDCCH indicates a wake-up, the terminal may perform a wake-up. In other words, an operation state of the terminal may transition to an active state, and the terminal in the active state (e.g., active mode) may perform a certain operation (e.g., PDCCH monitoring). The transition of the operation state of the terminal to the active state may mean that the terminal enters the active state. On the other hand, when the information included in the PDCCH indicates a sleep, the terminal may maintain a sleep state (e.g., sleep mode). According to the above-described method (e.g., UE power saving method), power consumption of the terminal may be reduced. A CRC of DCI (e.g., PDCCH) indicating the wake-up or the sleep of the terminal may be scrambled by a power saving (PS)-radio network temporary identifier (RNTI). When information included in the DCI (e.g., DCI scrambled with the PS-RNTI) is set to a first value (e.g., 0), the information may indicate the sleep. When the information included in the DCI (e.g., DCI scrambled with the PS-RNTI) is set to a second value (e.g., 1), the information may indicate the wake-up.

A paging early indication (PEI) may be introduced to reduce paging monitoring in a terminal in an RRC idle mode or an RRC inactive mode. A legacy terminal (e.g., a terminal not supporting PEI) may always monitor a periodically preconfigured paging occasion (PO). A terminal supporting PEI may monitor a DCI (e.g., PEI DCI) indicating early paging at a sufficiently earlier time than the preconfigured PO.

When the PEI DCI is received and a valid paging indication is identified from the PEI DCI, the terminal may determine that the terminal is to be paged soon and may monitor the next PO. The terminal may additionally perform an SSB measurement operation for synchronization and automatic gain control (AGC) if necessary. On the other hand, when the terminal does not receive the PEI DCI or when the terminal fails to identify a valid paging indication from the received PEI DCI, the terminal may expect that the terminal is not to be paged in the next PO. In this case, the terminal may enter a deep sleep mode and may operate with minimum power. The PEI DCI may be defined as a common DCI format 2_7. The PEI DCI may include information on a terminal subgroup. A base station may distinguish up to 8 terminal subgroups for each PO through one PEI DCI. The base station may independently transmit a PEI for each terminal subgroup. A terminal subgroup may be referred to as a UE subgroup.

A low-power wake-up signal (LP-WUS) may be used instead of DCI with CRC scrambled by PS-RNTI (DCP) and/or PEI. A terminal may include a low-power wake-up receiver (LP-WUR). In other words, the terminal may include a main radio or main receiver (MR) and an LP-WUR, and the MR may be used for transmitting and receiving signals other than low-power (LP) signals, and the LP-WUR may be used for transmitting and receiving LP signals. In the present disclosure, the LP-WUR may be referred to as LR. The LP signal may include an LP-WUS, a low-power synchronization signal (LP-SS), and the like. A terminal in a sleep state may perform a detection operation for LP-WUS by using the LR. When an LP-WUS is detected, an operating state of the terminal may be transitioned from the sleep state to an active state. The terminal in the active state may perform a PDCCH monitoring operation, a data reception operation, and/or a data transmission operation. The terminal in the active state may perform the above-described operations by using the MR. A method for replacing PEI for the terminal in an RRC idle mode and/or an RRC inactive mode is under discussion.

While the LP-WUR of the terminal performs a monitoring operation for LP-WUS detection, the MR of the terminal for PDCCH monitoring and/or data transmission and reception may maintain the sleep state. Therefore, an effect of power reduction may increase compared with an existing method. Methods for designing LP-WUS, operating in the RRC idle/inactive mode, and/or operating in the RRC connected mode may be required. The RRC idle/inactive mode may refer to the RRC idle mode and/or the RRC inactive mode. In the present disclosure, methods of transmitting and receiving information through LP signals (e.g., LP-WUS) are proposed.

LP-WUS may partially replace PEI functionality or operate in conjunction with PEI in the RRC idle mode. The terminal in the RRC idle mode may periodically check whether a network (e.g., a base station) transmits a paging message. For the above-described operation, the terminal may periodically wake up even in the RRC idle mode and may perform PDCCH monitoring for reception of a paging message at a paging occasion (PO). The terminal in the RRC idle mode may transition from the sleep state to a wake-up state and may perform PDCCH monitoring. When the terminal has been in the sleep state for a long time, the terminal may again perform a synchronization procedure (e.g., a time and/or frequency synchronization procedure), automatic gain control (AGC) procedure, and the like before PDCCH monitoring. For the synchronization procedure and AGC procedure, the terminal may receive at least three or more SSBs. Since a paging DCI is detected by a plurality of terminals sharing a PO and a P-RNTI, the terminal may finally check whether the paging is intended for the terminal after decoding a paging PDSCH. Therefore, the terminal may need to perform decoding not only for the paging DCI but also for the paging PDSCH. The above-described operations may cause significant power consumption of the terminal. To reduce power consumption of the terminal, the base station may transmit a PEI to the terminal before a PO period for paging monitoring. The PEI may be used to indicate to the terminal in advance whether the terminal wakes up in the corresponding period for paging monitoring or maintains the sleep state. The PEI may be delivered to the terminal through DCI (e.g., DCI format 2_7). A CRC of the DCI format 2_7 may be scrambled by a PEI-RNTI. The DCI format 2_7 may be designed such that the terminal receives the DCI format 2_7 after receiving SSB (e.g., one SSB). The terminal may receive the PEI after receiving one SSB and may determine an operating state of the terminal based on the PEI. For example, the terminal may wake up and monitor paging based on the PEI. Alternatively, the terminal may maintain the sleep state based on the PEI.

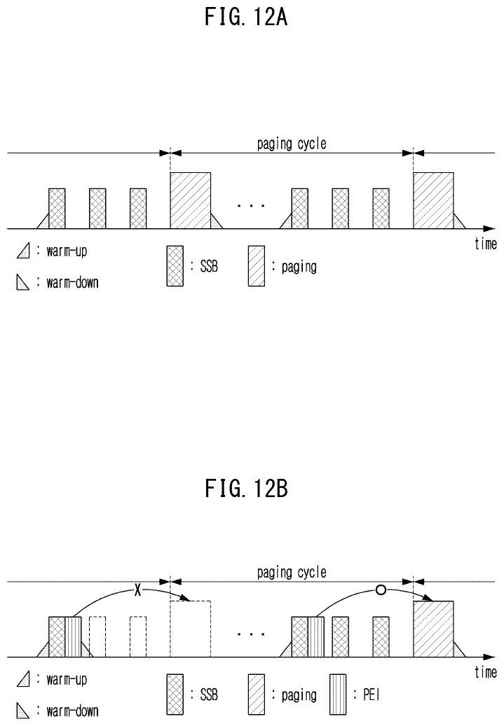

FIG. 12A is a conceptual diagram illustrating exemplary embodiments of paging monitoring.

Referring to FIG. 12A, a terminal may periodically wake up based on a paging cycle, and the terminal in the wake-up state may monitor paging.

FIG. 12B is a conceptual diagram illustrating exemplary embodiments of PEI-based paging monitoring.

Referring to FIG. 12B, a terminal may receive a PEI and may determine whether to wake up based on the PEI. When the terminal is determined to wake up, the terminal may wake up and monitor paging. The terminal may additionally receive SSB(s) and perform paging monitoring. The terminal may perform paging monitoring more quickly by receiving a tracking reference signal (TRS) instead of SSB before a paging monitoring period (e.g., paging cycle). When the terminal is determined not to wake up, the terminal may maintain the sleep state.

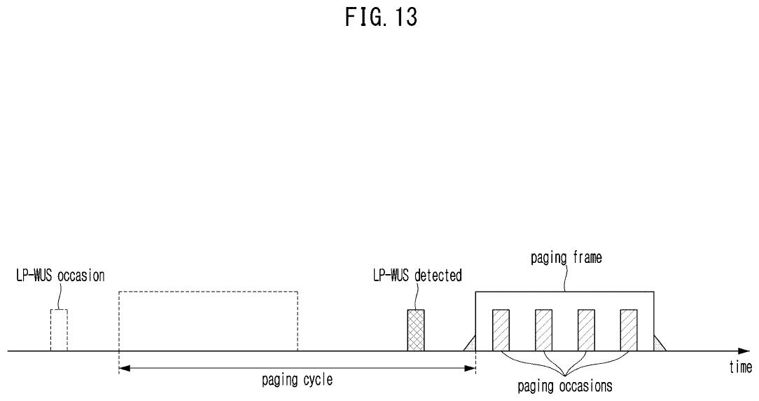

FIG. 13 is a conceptual diagram illustrating exemplary embodiments of an operation based on LP-WUS for paging monitoring indication.

Referring to FIG. 13, LP-WUS may be used instead of PEI. In other words, an LP-WUS may be used to indicate whether paging monitoring is to be performed. When LP-WUS-based paging monitoring indication is used, power consumption of the terminal may be smaller than power consumption of the terminal when PEI-based paging monitoring indication is used. A base station may configure an LP-WUS monitoring occasion for the terminal. In the present disclosure, the LP-WUS monitoring occasion may be referred to as LO. The terminal may perform LP-WUS monitoring at the preconfigured LO. When an LP-WUS sequence configured for the terminal is detected through the LP-WUS monitoring, the terminal may transition its operating state to the active state, and the terminal in the active state may perform paging monitoring. The active state may mean a state identical or similar to the wake-up state. The terminal that detects the LP-WUS sequence may transition its operating state back to the sleep mode after performing paging monitoring. When the LP-WUS sequence configured for the terminal is not detected, the terminal may maintain the sleep state without transitioning to the active state. The LP-WUS sequence configured for the terminal may mean a wake-up indicator.

Identically to the PEI-based paging monitoring, after the wake-up indicator is detected through the LP-WUS, the terminal may perform a synchronization procedure (e.g., time and/or frequency synchronization procedure), an AGC procedure, and the like for PO monitoring. For the above-described operation, the terminal may receive a plurality of SSBs. A time for receiving a sufficient number of SSBs between a detection time of the LP-WUS and an actual PO monitoring time needs to be guaranteed. Configuration of the LO for LP-WUS monitoring in consideration of the above-described time may be required.

The operating state of the terminal may be determined based on whether an LP-WUS is detected. For example, when an LP-WUS is detected, the operating state of the terminal may transition to the active state for paging monitoring. Alternatively, when an LP-WUS is not detected, the terminal may maintain the sleep state. The operating state of the terminal may transition from the active state back to the sleep state. An entity performing or transitioning an operating state may be a terminal, a terminal subgroup, or a terminal group. Each of the terminal subgroup and the terminal group may include one or more terminals. In the present disclosure, the terminal may be interpreted as a terminal subgroup or a terminal group according to a context.

An entity performing or transitioning an operating state may be configured in advance by a system (e.g., a network, a base station). When each terminal operates individually, an LP-WUS sequence may indicate an RNTI, a UE ID, or the like of each terminal. In this case, an effect of improving power consumption at each terminal may be large, but overhead may significantly increase due to signaling for each terminal. By grouping a plurality of terminals, a terminal group (or a terminal subgroup) may be configured. When a terminal group (or terminal subgroup) operates individually, an LP-WUS sequence may indicate a preconfigured UE group ID or most significant bit(s) (MSB(s)) of a UE ID (e.g., some bits of the ID). When signaling for each terminal group (or each terminal subgroup) is used, an effect of improving power consumption at each terminal may be smaller than an effect when signaling for each terminal is used. When signaling for each terminal group (or each terminal subgroup) is used, overhead may be smaller than overhead when signaling for each terminal is used. In other words, signaling may be efficient when signaling for each terminal group (or each terminal subgroup) is used.

When an LP-WUS sequence is generated based on MSB(s) of a UE ID (e.g., a portion of the UE ID, a portion of MSBs of the UE ID) (e.g., when the LP-WUS sequence transmits the MSB(s) of the UE ID), a terminal whose UE ID MSBs match the LP-WUS sequence may determine that an LP-WUS intended for the terminal has been detected. For example, when a UE ID has a size of 16 bits and an LP-WUS sequence has a size of 12 bits, the LP-WUS sequence may be configured based on 12 MSBs of the UE ID. All terminals whose 12 MSBs match the LP-WUS sequence may determine that an LP-WUS intended for the terminals has been detected, and the plurality of terminals may determine their operating state (e.g., active state, sleep state) according to a configuration, and may operate based on the determined operating state. The plurality of terminals in the active state may transition back to the sleep state. A maximum number of the plurality of terminals having the 12 MSBs of the UE ID matching the LP-WUS sequence may be 16. Based on four bits excluding the 12 bits of the LP-WUS sequence among the 16 bits constituting the UE ID, up to 16 terminals may be identified.

A terminal grouping method may be as follows. A core network (CN) may assign a terminal subgroup in consideration of a characteristic of each terminal (e.g., a mobility pattern, a paging probability, and the like). Alternatively, the CN may configure a terminal subgroup based on UE IDs (e.g., grouping terminals having similar UE IDs or grouping based on mathematical operations (e.g., modulo operations)). Based on one PEI DCI, up to 8 terminal subgroups may be distinguished for each PO, and PEI may be transmitted independently for each terminal subgroup.

When LP-WUS replaces PEI functionality, an LP-WUS may indicate, for each terminal subgroup, whether PO monitoring (e.g., paging monitoring) is to be performed. An LO for LP-WUS monitoring may include N×K LP-WUS monitoring occasions (MOs). N may be a number of beams for LP-WUS transmission, and K may be a number of LP-WUS MOs per beam. In other words, K may be a number of LP-WUS MOs associated with one beam. Each of N and K may be a natural number. Since multi-beam transmission is supported in the RRC idle mode, K LP-WUS MOs may be configured for each of N beams. K may be configured in consideration of a number of terminal subgroups. Specifically, an LP-WUS sequence may indicate one codepoint, and the codepoint may indicate one or more terminal subgroups for one or more POs. The LP-WUS sequence may support up to 32 codepoints.

LP-WUS and PO may be configured to have a one-to-one relationship (e.g., mapping relationship) or a one-to-M (M>1) relationship (e.g., mapping relationship). When LP-WUS and PO have a one-to-one relationship, LO may be configured to correspond to each PO. When LP-WUS and PO have a one-to-M relationship, one LO may be configured for a plurality of POs. When LP-WUS and PO are configured to have a one-to-one relationship, an effect of reducing power consumption of the terminal according to PO monitoring may be maximized, but LP-WUS overhead may increase. When LP-WUS and PO are configured to have a one-to-M relationship, LP-WUS overhead for indicating PO monitoring may decrease, but an effect of reducing power consumption of the terminal according to PO monitoring may decrease. When LO and PO are configured to have a one-to-one relationship, LO may be configured using an offset (e.g., offset value) based on a frame in which PO is configured (e.g., a paging frame, a PO frame). When LO and PO are configured to have a one-to-M relationship, the base station may configure, in advance, a value of M for the terminal, all POs may be grouped in units of M POs, and LO may be configured using an offset based on a frame in which the first PO of each PO group is configured. A unit of the offset may be at least one of a symbol, a slot, a subframe, or a radio frame.

Based on the above-described configuration, each codepoint of LP-WUS may indicate one terminal subgroup for one PO or a plurality of POs. Alternatively, each codepoint of LP-WUS may indicate a plurality of terminal subgroups. When LP-WUS is used to replace PEI functionality, it may be preferable that an LP-WUS supports up to 8 terminal subgroups identically to PEI. In this case, the above-described existing terminal grouping method may be reusable without modification or supplementation. In LO configuration, a start time (e.g., start point) of an LO may be configured based on an offset for a PO, and MOs may be configured sequentially for the respective terminal subgroups within the LO. When an LP-WUS is transmitted through N beams, the above-described pattern (e.g., MO configuration pattern) may be repeatedly configured N times. N may be a natural number.

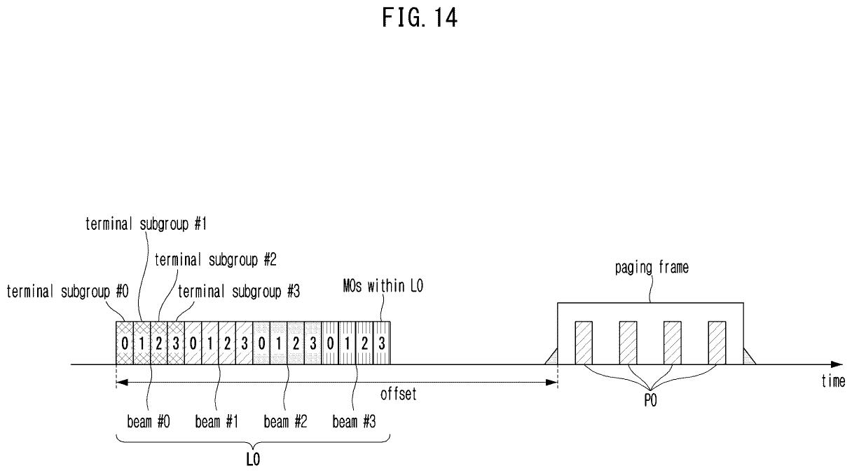

FIG. 14 is a conceptual diagram illustrating exemplary embodiments of LO configuration for PEI through LP-WUS.

Referring to FIG. 14, an offset for a start time of an LO may be configured based on a PO. In other words, an offset for a start time of an LO may be configured based on a start time of a paging frame in which a PO is configured. A total number N of beams may be 4, and a number K of MOs for each beam may be 4. The total number N of beams may refer to a total number of beams used for LP-WUS transmission. In this case, positions of MOs within the LO may be configured without additional configuration information. In other words, a communication node (e.g., a base station and/or a terminal) may determine the positions of the MOs within the LO based on the total number N of beams and the number K of MOs associated with each of the beams. The positions of the MOs within the LO may be implicitly determined based on N and K. Information on the total number N of beams and/or the number K of MOs for each beam may be included in LO configuration information. The base station may transmit the LO configuration information to the terminal through signaling (e.g., system information (SI) signaling, RRC signaling, MAC signaling, PHY signaling). The terminal may receive the LO configuration information through signaling of the base station.

4 MOs (e.g., 4 LP-WUS MOs) for an LP-WUS transmitted through beam #0 may be configured, 4 MOs for an LP-WUS transmitted through beam #1 may be configured, 4 MOs for an LP-WUS transmitted through beam #2 may be configured, and 4 MOs for an LP-WUS transmitted through beam #3 may be configured. The MOs for the beams may be configured sequentially. The offset indicating the start time of the LO based on the PO may be configured as offsets of two types. For example, the offset may be configured as a combination of a frame-level offset and a slot-level offset, or may be configured as a combination of a frame-level offset and a symbol-level offset. The frame-level offset may indicate a frame in which the LO is configured (e.g., a start time of the first frame or an end time of the last frame) based on the paging frame. The communication node (e.g., the base station and/or the terminal) may determine a time before the frame-level offset from a start time of the paging frame as the frame in which the LO is configured. The frame in which the LO is configured may be referred to as an LO frame. The LO frame may include one or more frames.

The slot-level offset may indicate a slot in which the LO (e.g., actual LO) starts within the frame (e.g., LO frame) indicated by the frame-level offset. The communication node may determine a time after the slot-level offset from the start time of the LO frame as the start time of the LO. The base station may transmit an LP-WUS to the terminal from the start time of the LO or after the start time of the LO. The terminal may perform monitoring for LP-WUS reception from the start time of the LO or after the start time of the LO. The symbol-level offset may indicate a symbol in which the LO (e.g., actual LO) starts within the frame (e.g., LO frame) indicated by the frame-level offset. The communication node may determine a time after the symbol-level offset from the start time of the LO frame as the start time of the LO. The base station may transmit an LP-WUS to the terminal from the start time of the LO or after the start time of the LO. The terminal may perform monitoring for LP-WUS reception from the start time of the LO or after the start time of the LO.

In the exemplary embodiment of FIG. 14, one terminal subgroup may be configured to correspond to one MO. Alternatively, a plurality of terminal subgroups may be configured to correspond to one MO. For example, when two terminal subgroups are configured for each MO, {terminal subgroup #0, terminal subgroup #1} may be configured in a first MO, {terminal subgroup #2, terminal subgroup #3} may be configured in a second MO, {terminal subgroup #4, terminal subgroup #5} may be configured in a third MO, and {terminal subgroup #6, terminal subgroup #7} may be configured in a fourth MO. Configuration information of the terminal subgroups for the MOs may be included in the LO configuration information. When an LP-WUS is detected in an MO, terminals belonging to terminal subgroup(s) associated with the MO may perform monitoring for a PO associated with an LO to which the MO belongs.

When a number of POs associated with an LO is smaller than a number of POs within a paging frame (PF), a wake-up through one LO may be indicated for some POs within the PF, and a wake-up through another LO may be indicated for remaining POs within the PF. To support the above-described operation, a plurality of LOs may be configured for one PF. In this case, a plurality of frame-level offsets may be configured based on a frame (e.g., first frame) in which the PF is configured, and the slot-level offset and/or the symbol-level offset may be commonly applied within the frame in which each LO is configured. For example, a first frame-level offset indicating a first LO frame (e.g., a start time or an end time of the first LO frame) based on the start time of the PF may be configured for the terminal, and a second frame-level offset indicating a second LO frame (e.g., a start time or an end time of the second LO frame) based on the start time of the PF may be configured for the terminal. Each of the first LO frame and the second LO frame may include one or more frames. In the time domain, the first LO frame and the second LO frame may be consecutive or may not be consecutive.

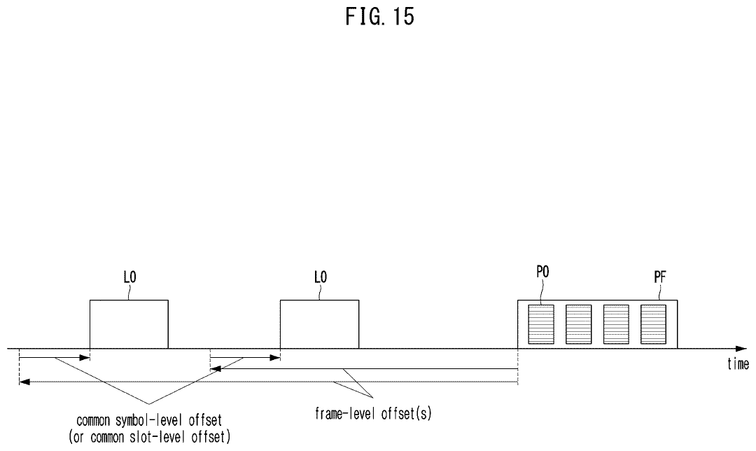

FIG. 15 is a conceptual diagram illustrating exemplary embodiments related to configuration of multiple LOs.

Referring to FIG. 15, a plurality of POs may be configured within one PF, and a plurality of LOs associated with the one PF may be configured for a terminal. In order to configure two LOs associated with one PF, two frame-level offsets indicating frames (e.g., respective first frames) in which the respective two LOs are configured based on a frame (e.g., the first frame) of the PF may be configured for the terminal. A symbol-level offset (or a slot-level offset) indicating an actual LO configured within an LO frame may be commonly configured for the terminal for the two LOs. The LO frame may include one or more frames in which an LO (e.g., actual LO) is configured. A base station may transmit at least one among the frame-level offset(s), the symbol-level offset (e.g., common symbol-level offset), or the slot-level offset (e.g., common slot-level offset) to the terminal through signaling. The terminal may receive at least one among the frame-level offset(s), the symbol-level offset (e.g., common symbol-level offset), or the slot-level offset (e.g., common slot-level offset) through signaling from the base station. The communication node (e.g., the base station and/or the terminal) may determine a start time of a first LO based on the “first frame-level offset and the common slot-level offset” or based on the “first frame-level offset and the common symbol-level offset”. The communication node (e.g., the base station and/or the terminal) may determine a start time of a second LO based on the “second frame-level offset and the common slot-level offset” or based on the “second frame-level offset and the common symbol-level offset”.

When a plurality of terminal subgroups are configured for one MO, one codepoint of LP-WUS may be configured for the MO. Based on the configuration, the base station may instruct the terminal to perform concurrent PO monitoring for the plurality of terminal subgroups by using an LP-WUS (e.g., codepoint). A plurality of LP-WUS codepoints may be configured for the terminal, and based on the configuration, the base station may indicate to the terminal whether to perform PO monitoring for each of the plurality of terminal subgroups. One LP-WUS codepoint may be mapped to one or more terminal subgroups. Since only one LP-WUS for one MO is transmittable, when PO monitoring for one terminal subgroup is indicated, the base station may fail to indicate PO monitoring for another terminal subgroup associated with the MO.

In order to prevent the problem described above, when a plurality of terminal subgroups are configured for one MO, the base station may configure a codepoint (e.g., individual codepoint) for each terminal subgroup and may additionally configure an additional codepoint (e.g., a common codepoint) for indicating all terminal subgroups belonging to the MO. For example, when two terminal subgroups are allocated to one MO, the base station may configure three codepoints (e.g., codepoint #0, codepoint #1, codepoint #2) for the MO for the terminal. For example, codepoint #0 may indicate terminal subgroup #0 to perform PO monitoring, codepoint #1 may indicate terminal subgroup #1 to perform PO monitoring, and codepoint #2 may indicate terminal subgroup #0 and terminal subgroup #1 to perform PO monitoring. Codepoint #0 and codepoint #1 may be individual codepoints, and codepoint #2 may be a common codepoint. Based on the configuration described above, not only indication for PO monitoring for each terminal subgroup but also indication for PO monitoring for a plurality of terminal subgroups (e.g., all terminal subgroups) may be possible. Therefore, the above-described problem may be resolved. Although, in the exemplary embodiment of FIG. 14, MOs within an LO are configured in a time-division multiplexing (TDM) manner, the MOs may be configured within the LO based on a frequency-division multiplexing (FDM) manner or based on a combination of the TDM manner and the FDM manner. When the MOs are configured based on the TDM manner and the FDM manner, a number of MOs configurable within the LO may increase.

When one LO is associated with a plurality of POs, in the exemplary embodiment of FIG. 14, one MO for each beam may be configured to correspond to each PO. For example, when one LO corresponds to one PO, two POs, or four POs, in the exemplary embodiment of FIG. 14, the number of MOs for each beam may be configured to be one, two, or four, identical to the number of POs associated with the LO. In this case, PO monitoring for terminal subgroups associated with a PO corresponding to an MO for each beam may be performed. The performance of the operation may be indicated to the terminal. Even in this case, as in the exemplary embodiment described above, each of terminal subgroup belonging to each PO may be indicated. Alternatively, all terminal subgroups associated with (e.g., belonging to) each PO may be indicated.

A maximum number of terminal subgroups indicatable in one LO may be defined in the technical specifications. The maximum number of terminal subgroups may vary according to the number of POs corresponding to one LO. For example, when one PO corresponds to one LO, a maximum number of terminal subgroups indicatable through LP-WUS may be 32. When two POs correspond to one LO, a maximum number of terminal subgroups indicatable for each PO may be 16. When four POs correspond to one LO, a maximum number of terminal subgroups indicatable for each PO may be 8. A maximum number of codepoints indicatable through an LP-WUS may be 32. One codepoint may be mapped to one terminal subgroup.

In each of the exemplary embodiments described above, the LP-WUS may be configured to indicate each of the terminal subgroups or may be configured to indicate all terminal subgroups belonging to a PO. The base station may transmit the LP-WUS configuration information described above to the terminal through signaling. The terminal may identify the LP-WUS configuration information described above through signaling from the base station. The LP-WUS configuration information may be included in the LO configuration information. Based on the LP-WUS configuration described above, according to a one-to-one mapping relationship between LO and PO, an LP-WUS may be able to indicate one of (a maximum of) 31 terminal subgroups for one PO (e.g., individual terminal subgroups) and/or the entire subgroups for one PO (e.g., all terminal subgroups).

Based on the LP-WUS configuration described above, based on a one-to-two mapping relationship between LO and PO, an LP-WUS may be able to indicate one of (a maximum of) 15 terminal subgroups for each of the two POs (e.g., individual terminal subgroups) and/or the entire terminal subgroups for each of the two POs (e.g., all terminal subgroups). Based on the LP-WUS configuration described above, according to a one-to-four mapping relationship between LO and PO, an LP-WUS may be able to indicate one of (a maximum of) 7 terminal subgroups for each of the four POs (e.g., individual terminal subgroups) and/or the entire terminal subgroups for each of the four POs (e.g., all terminal subgroups). Each of the plurality of terminal subgroups may be indicated by an individual codepoint. All terminal subgroups within each of the POs may be indicated by a common codepoint.

In another method, when one LO is associated with a plurality of POs, a plurality of MOs for each beam may be configured to correspond to each PO. For example, when one LO corresponds to two POs, if a number of MOs for each beam is four, two MOs may be configured to correspond to one PO. When one LO corresponds to one PO, if the number of MOs for each beam is four, all four MOs may be configured to correspond to one PO.

When an LO is configured as in the exemplary embodiment of FIG. 12, the terminal may perform LP-WUS monitoring within the LO, may perform a wake-up operation for PO monitoring when an LP-WUS indicates PO monitoring, and may perform PO monitoring at the first PO after a delay time of the wake-up operation. An offset indicating a start time of the LO based on the PO may be appropriately configured considering the last MO within the LO, a start time of the PO, or a wake-up delay time of the terminal.

When a time from some of the MOs within the LO to a start time of the PO is smaller than a minimum time considering the wake-up delay time of the terminal, the terminal may not perform LP-WUS monitoring at the some of the MOs. When the terminal does not perform LP-WUS monitoring at the some of the MOs, the terminal may perform paging monitoring at POs associated with the some of the MOs even when a separate wake-up indication does not exist. In this case, the terminal may perform a wake-up operation at an appropriate time considering the wake-up delay time of the terminal. Alternatively, when the terminal does not perform LP-WUS monitoring at the some of the MOs, the terminal may not perform paging monitoring at POs associated with the some of the MOs.

In another method, even when a time from some of the MOs within the LO to a start time of the PO is smaller than the minimum time considering the wake-up delay time of the terminal, the terminal may perform LP-WUS monitoring at the some of the MOs. When a wake-up signal is detected through LP-WUS monitoring at the some of the MOs, the terminal may perform paging monitoring at the next PO instead of performing paging monitoring at a PO associated with each of the some of the MOs.

The LO configuration information may be transmitted to the terminal in the RRC idle mode. In order to support the above operation, the LO configuration information may be transmitted through system information. For example, the base station may transmit an SIB1 including the LO configuration information to the terminal. The terminal may receive the SIB1 from the base station and may acquire the LO configuration information included in the SIB1. The LO configuration information may include offset information (e.g., frame-level offset, slot-level offset, symbol-level offset, MO configuration information, a number of beams, a number of MOs associated with each beam).

The base station may transmit PO configuration information to the terminal through signaling (e.g., system information, RRC message). The terminal may receive the PO configuration information through signaling from the base station. In a PO monitoring procedure, since the terminal knows the PO configuration information, the terminal may acquire synchronization and information on a current time (e.g., information of an SFN, a slot, and/or a symbol) based on an SSB and, based on the acquired information, may perform PO monitoring. A terminal supporting low-power operation may receive an LP-SS instead of the SSB in the RRC idle mode or the RRC inactive mode. Since an LP-SS does not include time information, it may be difficult for the terminal to perform LO monitoring and/or PO monitoring based on the LP-SS.

When a terminal receives LO configuration information and/or PO configuration information before transitioning from the active state to the sleep mode, and acquires time information based on SSB reception, the terminal may acquire synchronization information based on an LP-SS while maintaining the above-described information (e.g., the LO configuration information, the PO configuration information, and/or the time information). In this case, the terminal may perform LO monitoring even in the sleep state based on the above-described information, and may perform PO monitoring in association with an LP-WUS detected by the LO monitoring. It may be difficult to guarantee that all terminals maintain the time information acquired based on SSB reception. In other words, it may be difficult to guarantee that a terminal in the sleep state maintains the time information acquired in the active state. LP-SS may not include general time information such as that of SSB. A method for the terminal that receives an LP-SS in the RRC idle/inactive mode to perform LO monitoring (e.g., LP-WUS monitoring) and PO monitoring in association with the LO monitoring may be needed. In the present disclosure, methods for performing LO monitoring and PO monitoring associated with the LO monitoring for the terminal that receives the LP-SS without time information (e.g., accurate time information) acquired through the SSB are proposed.

In order for a terminal in the RRC idle/inactive mode to perform LO monitoring and/or PO monitoring based on an LP-SS without time information (e.g., accurate time information) acquired through SSB, it may be preferable to configure an LO in association with a transmission time and/or a periodicity of the LP-SS. Specifically, the LO may be configured to have a periodicity identical to an LP-SS periodicity. Alternatively, the LO may be configured to have a periodicity as a multiple or a divisor of the LP-SS periodicity. For example, when the LP-SS periodicity is 160 ms, the LO periodicity may be configured identically to 160 ms. Alternatively, the LO periodicity may be configured as 320 ms, which is a multiple of the LP-SS periodicity, or 40 ms, 80 ms, or 160 ms, which are divisors of the LP-SS periodicity. An LO monitoring time may be configured to be indicated by a specific offset based on an LP-SS transmission time. When the LO is configured based on the above-described methods, the terminal receiving the LP-SS may determine the LO monitoring time based on a periodicity relation between the LP-SS and the LO and/or based on an offset between the LP-SS transmission time and the LO monitoring time, and may additionally perform PO monitoring based on an offset between the LO monitoring time and a PO monitoring time.

Alternatively, when the LO is configured based on the PO configuration information, the LP-SS may be configured based on the LO. Specifically, when the LO monitoring time is configured based on a PO (e.g., a reference PO or a reference paging frame), the LP-SS periodicity may be configured as a periodicity identical to that of the LO, a multiple of the LO periodicity, or a divisor of the LO periodicity, and an LP-SS transmission time may be configured based on a specific offset based on the LO monitoring time. When the LP-SS periodicity is identical to the LO periodicity or when the LP-SS periodicity is a divisor of the LO periodicity, the communication node (e.g., the base station and/or the terminal) may determine an LP-SS transmission time by applying a specific offset based on an arbitrary LO. When the LP-SS periodicity is a multiple of the LO periodicity, the communication node may determine an LP-SS transmission time by applying a specific offset based on a specific LO. For example, when the LP-SS periodicity is M times the LO periodicity, the specific LO may be an LO satisfying (#LO mod M)=x. #LO may indicate an index of the LO, M may be a natural number, and x may be 0, 1, . . . , X−1. X may be a natural number. The value x may be defined as a specific value in the technical specifications. Alternatively, the base station may configure the value x to the terminal through signaling.

In another method, the LP-SS periodicity and the LP-SS transmission time may be configured regardless of the LO configuration information and/or PO configuration information. Specifically, when the LP-SS periodicity is configured as Y ms, the LP-SS transmission time may be determined as a time satisfying (SFN mod (Y/10))=z. Y may be a natural number. z may be 0, 1, . . . , Z−1. Z may be a natural number. The value z may be defined as a specific value in the technical specifications. Alternatively, the base station may configure the value z to the terminal through signaling. A specific offset may be applied to determine the LP-SS transmission time. The specific offset may be configured in units of symbols, slots, subframes, and/or frames. The base station may configure the specific offset to the terminal through signaling.

The above-described configuration information (e.g., LP-SS configuration information, x, z, or offset) may be included in LP-WUS configuration information (e.g., LO configuration information), and the base station may transmit system information including the LP-WUS configuration information to the terminal. The terminal may receive the system information from the base station, and may identify the LP-WUS configuration information included in the system information. Alternatively, the base station may transmit system information including separate LP-SS configuration information to the terminal.

In the RRC idle/inactive mode, LP-WUS may not be configured to replace PEI functionality. In other words, LP-WUS and PEI may be configured simultaneously. In this case, for efficient operations, it may be preferable for the terminal to monitor LP-WUS and PEI sequentially. A terminal (e.g., a terminal group or a terminal subgroup) indicated by an LP-WUS and a terminal (e.g., a terminal group or a terminal subgroup) indicated by a PEI may be configured independently. In other words, a terminal subgroup indicated by an LP-WUS (e.g., a terminal group, terminal subgroup) may be configured differently from a terminal (e.g., terminal group or terminal subgroup) indicated by a PEI. A terminal subgroup indicated by an LP-WUS may be referred to as an LP-WUS subgroup. A terminal subgroup indicated by a PEI may be referred as a PEI subgroup. Specifically, the LP-WUS subgroup and the PEI subgroup may be configured in a 1-to-M relation (e.g., mapping relation), and based on one LP-WUS, M PEI monitoring subgroups may be woken up. M may be a natural number. Alternatively, the LP-WUS subgroup and the PEI subgroup may be configured in an N-to-1 relation (e.g., mapping relation), and one LP-WUS may wake up a portion of a PEI subgroup. N may be a natural number.

In the RRC connected mode, LP-WUS may support various operations. For example, LP-WUS may replace a DCP (DCI with CRC scrambled by PS-RNTI) operation associated with C-DRX. In the DCP scheme, a wake-up/sleep indication through PDCCH monitoring may be performed through an LP-WUS. Specifically, a terminal configured with C-DRX may perform LP-WUS monitoring through an LR prior to a C-DRX on-duration, and when an LP-WUS is detected, an MR of the terminal may wake up to transition to the active state, and perform PDCCH monitoring in the active state. When an LP-WUS is not detected, the terminal may maintain the sleep state during the C-DRX on-duration. According to the above-described operation, power consumption of the terminal may be reduced.

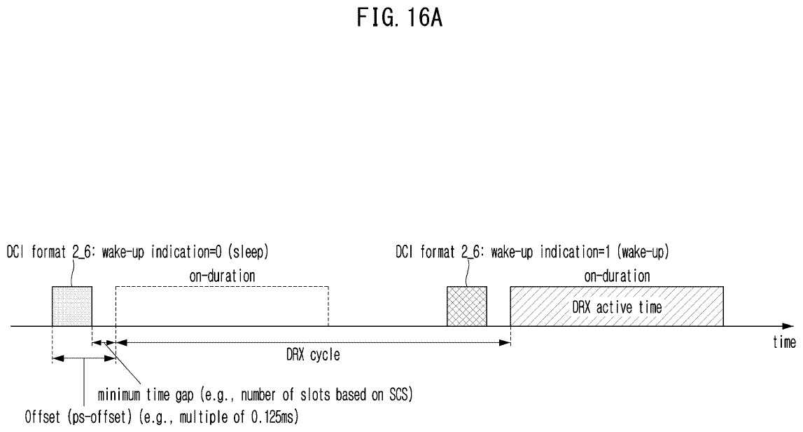

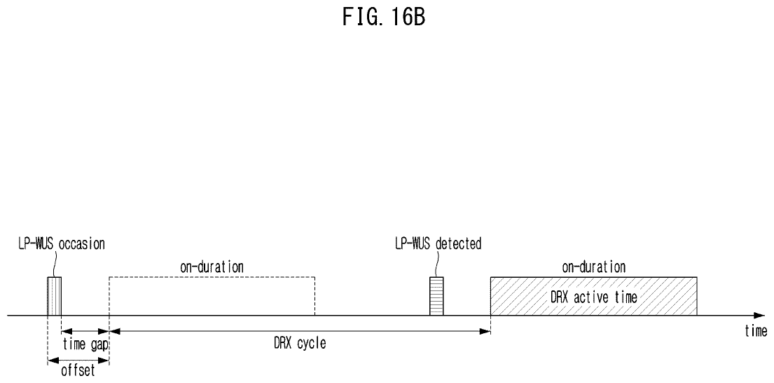

FIG. 16A and FIG. 16B are conceptual diagrams illustrating exemplary embodiments of DCP and LP-WUS operations.

Referring to FIG. 16A and FIG. 16B, an LR of a terminal may perform LP-WUS monitoring at an LO in which an LP-WUS is transmittable, and when an LP-WUS is detected, an MR of the terminal may wake up, and the terminal may transition to a C-DRX active state. When an LP-WUS is not detected, the terminal may maintain a sleep state. The terminal may perform LO monitoring at a time preceding the C-DRX on-duration by a specific offset. An LO may include N×K LP-WUS MOs. An LO periodicity may be configured. The LO periodicity may be configured considering a C-DRX periodicity (e.g., C-DRX configuration periodicity). Specifically, the LO periodicity may be configured identically to the C-DRX periodicity. Alternatively, the LO periodicity may be configured as a multiple of the C-DRX periodicity. When the LO periodicity is configured as a multiple of the C-DRX periodicity, an operation indicated by an LP-WUS may be applied identically to all C-DRX durations included in an LP-WUS period. For example, when the LP-WUS periodicity is configured as M times the C-DRX periodicity, the terminal may perform an operation indicated by the same LP-WUS in M C-DRX durations included in an LP-WUS period. M may be a natural number. When an LP-WUS indicates a wake-up, the terminal may wake up in M C-DRX durations and may perform PDCCH monitoring. When an LP-WUS indicates sleep-on (e.g., sleep state) or when an LP-WUS is not detected, the terminal may not perform PDCCH monitoring in M C-DRX durations. The sleep-on may indicate maintenance of the sleep state. In an LP-WUS monitoring procedure for an LO, when a time (e.g., time gap) required for a transition to the active state of the terminal is considered, the last MO in the LO may be the last MO that is monitorable.

When a terminal in the RRC connected mode identifies a PDCCH monitoring indication based on an LP-WUS, unlike in the RRC idle mode, PDCCH monitoring may be indicated for an individual terminal or a plurality of terminals, rather than a terminal subgroup. One codepoint indicated by the LP-WUS sequence may indicate PDCCH monitoring for an individual terminal or a plurality of terminals. In another method, each bit of a bitmap indicated by the LP-WUS sequence may indicate PDCCH monitoring for an individual terminal or a plurality of terminals.

When PDCCH monitoring for an individual terminal is indicated through one codepoint, the one codepoint may be an ID (e.g., UE ID) or C-RNTI of the terminal. When PDCCH monitoring for a plurality of terminals is indicated through one codepoint, the one codepoint may be a portion (e.g., MSB(s)) of bits of the ID (e.g., UE ID) or C-RNTI of the terminal. In another method, similarly to the above-described terminal grouping, a terminal subgroup including a plurality of terminals may be configured, and the one codepoint may be an ID (e.g., a portion of bits of the ID) of the terminal subgroup.

A plurality of LOs may be configured to a terminal, and a specific codepoint may be allocated to a specific LO among the plurality of LOs. Terminal(s) configured to monitor the same LO may identify an LO monitoring indication based on a codepoint allocated to the same LO. In another method, a CORESET index for PDCCH monitoring of a terminal at a PDCCH monitoring time (e.g., C-DRX on-duration) may be indicated by a codepoint. When a CORESET index is indicated by a codepoint, terminals that perform PDCCH monitoring in a CORESET having the CORESET index in a next PDCCH monitoring duration may perform actual PDCCH monitoring.

When an LP-WUS includes one or more bitmaps, each bitmap may indicate whether to wake up each terminal. Similarly to the above-described terminal grouping, a terminal subgroup including a plurality of terminals may be configured. Alternatively, a terminal subgroup may be configured through separate signaling. For example, a terminal subgroup ID may be configured to each terminal through UE-specific RRC signaling. LO configuration information may include information indicating that a terminal subgroup monitors a specific LO. In other words, monitoring of a specific LO by a terminal subgroup may be configured (e.g., indicated) to a terminal (e.g., terminal subgroup) through LO configuration information.

A bitmap indicated by an LP-WUS sequence transmitted in an LO that is indicated to be monitored by a terminal subgroup may indicate whether to wake up each terminal in the terminal subgroup. A size (e.g., length) of the bitmap may be identical to a size of the terminal subgroup for which LO monitoring is configured (e.g., a number of terminals included in the terminal subgroup). The size of the bitmap may be defined as a specific value in the technical specifications. Alternatively, the base station may transmit information on the size of the bitmap to the terminal through signaling. The terminal may identify the information on the size of the bitmap through signaling from the base station. A specific terminal in the terminal subgroup may determine whether to wake up based on information of a bit (e.g., bit value) of a specific position in the bitmap. A method for interpreting a bit position and/or bit information in the bitmap may be included in LP-WUS configuration information (e.g., LO configuration information). In other words, the method for interpreting a bit position and/or bit information in the bitmap may be preconfigured to the terminal. For example, when a specific bit in the bitmap is configured as a first value (e.g., 1), the specific bit may indicate a wake-up of terminal(s) associated with the specific bit. When a specific bit in the bitmap is configured as a second value (e.g., 0), the specific bit may indicate sleep-on (e.g., maintenance of a sleep state) of terminal(s) associated with the specific bit.

The LP-WUS configuration information may include LO configuration information for LP-WUS transmission and reception. Alternatively, the LP-WUS configuration information may be included in the LO configuration information. Alternatively, the LP-WUS configuration information and the LO configuration information may indicate identical configuration information. The base station may transmit the LP-WUS configuration information to the terminal through signaling (e.g., system information or UE-specific RRC signaling). In the RRC connected mode, the base station may transmit the LP-WUS configuration information to each terminal through UE-specific RRC signaling. Common information among terminals in the LP-WUS configuration information may be transmitted to the terminals through SI signaling (e.g., system information).

In the RRC connected mode, a terminal may fail to perform LP-WUS monitoring in a specific situation. For example, when a time of Semi-Persistent Scheduling (SPS) reception, periodic CSI reporting, or SRS transmission overlaps an LP-WUS monitoring time, the terminal may fail to perform LP-WUS monitoring (e.g., LO monitoring). The terminal may wake up from a sleep state for SPS reception, periodic CSI reporting, or SRS transmission, and an MR of the terminal may perform the SPS reception, periodic CSI reporting, or SRS transmission. When a terminal fails to perform LP-WUS monitoring in the above-described situation, the terminal may fail to perform monitoring for an indicator indicating whether to wake up in the next PDCCH monitoring duration (e.g., a C-DRX duration or a PDCCH monitoring duration based on a specific timer). To solve the above-described problem, even when the terminal fails to perform LO monitoring, the terminal may wake up in the next PDCCH monitoring duration and may perform PDCCH monitoring. In another method, when a terminal fails to perform LO monitoring, the terminal may determine that a wake-up indicator is not detected and may not wake up in the next PDCCH monitoring duration. In other words, the terminal may skip a PDCCH monitoring operation in the next PDCCH monitoring duration.

Resources in which an LP-WUS is transmitted may be configured by the base station. Information on LP-WUS transmission resources may be included in LP-WUS configuration information. The base station may transmit the LP-WUS configuration information to the terminal through signaling (e.g., SI signaling or UE-specific RRC signaling). The terminal may receive the LP-WUS configuration information through signaling from the base station, and may determine whether to perform LP-WUS monitoring in a specific resource based on information included in the LP-WUS configuration information.

LP-WUS resources may be configured (e.g., indicated) by a unit-level bitmap. The unit-level bitmap may indicate whether an LP-WUS resource is configured in a unit composed of one slot or two slots. Each unit may include one slot or two slots. A configuration periodicity of the slot(s) (e.g., a unit) may be 10 slots, 20 slots, or 40 slots. When a specific bit in the unit-level bitmap is configured as a first value (e.g., 1), a unit associated with the specific bit may be used for LP-WUS transmission. When a specific bit in the unit-level bitmap is configured as a second value (e.g., 0), a unit associated with the specific bit may not be used for LP-WUS transmission. When the unit-level bitmap is not configured, the terminal may assume that all bits in the unit-level bitmap are configured as the first value (e.g., 1). In other words, all units may be used for LP-WUS transmission.

A symbol-level bitmap indicating whether each symbol in a unit composed of one slot or two slots is used as an LP-WUS resource may be configured to the terminal. When a unit includes one slot, a size of the symbol-level bitmap may be 14 bits. When a unit includes two slots, a size of the symbol-level bitmap may be 28 bits.

Based on the two bitmaps (e.g., the unit-level bitmap and the symbol-level bitmap), LP-WUS resources may be configured, and whether an actual LP-WUS is transmitted within an LP-WUS resource may be determined based on a nominal MO duration and an actual LP-WUS duration. Generally, the nominal MO duration may be configured to be equal to or greater than the actual LP-WUS duration. The base station may apply the nominal MO duration within the LP-WUS resources indicated by the above-described bitmaps, and may transmit an LP-WUS in a resource satisfying the actual LP-WUS duration within the nominal MO duration. The terminal may expect that an LP-WUS is received in a resource determined based on the above-described method.

For example, when the nominal MO duration consists of 8 symbols and the actual LP-WUS duration consists of 6 symbols, when 6 actual symbols among consecutive 8 symbols in the LP-WUS resources (e.g., symbols in which LP-WUS resources are configured) indicated by the above-described bitmaps are used for LP-WUS transmission, the nominal MO duration may be determined as an MO in which an actual LP-WUS is transmitted.

When only the LP-WUS resources configured by the bitmaps (e.g., symbols configured as LP-WUS resources) are considered, among the consecutive 8 symbols (e.g., the nominal MO duration) within the LP-WUS resources, some symbol(s) may exist that are used for transmission/reception of other signals and/or channels. When a number of symbols, excluding the some symbol(s) among the consecutive 8 symbols, is less than 6 symbols (e.g., the actual LP-WUS duration), the duration (e.g., the nominal MO duration) may be determined as an MO in which LP-WUS transmission is impossible. The LP-WUS resource configuration method may be applicable to the RRC idle mode, the RRC inactive mode, and the RRC connected mode.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
receiving, from a base station, low-power wake-up signal (LP-WUS) monitoring occasion (LO) configuration information including a first offset and a second offset;
determining, in a time domain, a frame before the first offset from a paging occasion (PO) as an LO frame in which an LO is configured;
determining a time after the second offset from a start time of the LO frame as a start time of the LO; and
performing a monitoring operation of an LP-WUS from the start time of the LO.

2. The method of claim 1, wherein the first offset is a frame-level offset configured in units of frames, and the second offset is a slot-level offset configured in units of slots or a symbol-level offset configured in units of symbols.

3. The method of claim 1, wherein based on a configuration of a plurality of LOs associated with the PO, the LO configuration information includes the first offset for each of the plurality of LOs.

4. The method of claim 1, wherein the LO configuration information further includes information indicating a number of beams used for LP-WUS transmission and information indicating a number of LP-WUS monitoring occasions (MOs) for each of the beams, the LO includes the LP-WUS MOs, and positions of the LP-WUS MOs within the LO are determined based on the number of beams and the number of LP-WUS MOs.

5. The method of claim 1, further comprising performing a monitoring operation for reception of paging in one or more POs mapped to the LO, based on the LP-WUS detected by the monitoring operation indicating a wake-up of the terminal.

6. The method of claim 1, wherein the LP-WUS indicates one or more terminal subgroups that perform a monitoring operation for reception of paging in one or more POs mapped to the LO, and each of the one or more terminal subgroups includes one or more terminals.

7. The method of claim 6, wherein the LP-WUS supports up to 32 codepoints to indicate the one or more terminal subgroups.

8. The method of claim 6, wherein based on the LO and the PO having a 1-to-1 mapping relation, the LP-WUS indicates up to 31 terminal subgroups for one PO or an entire set of terminal subgroups for the one PO.

9. The method of claim 6, wherein based on the LO and the PO having a 1-to-2 mapping relation, the LP-WUS indicates up to 15 terminal subgroups for each of two POs or an entire set of terminal subgroups for each of the two POs.

10. The method of claim 6, wherein based on the LO and the PO having a 1-to-4 mapping relation, the LP-WUS indicates up to 7 terminal subgroups for each of four POs or an entire set of terminal subgroups for each of the four POs.

11. A method of a base station, comprising:
transmitting, to a terminal, low-power wake-up signal (LP-WUS) monitoring occasion (LO) configuration information including a first offset and a second offset;
determining, in a time domain, a frame before the first offset from a paging occasion (PO) as an LO frame in which an LO is configured;
determining a time after the second offset from a start time of the LO frame as a start time of the LO; and
transmitting an LP-WUS to the terminal after the start time of the LO.

12. The method of claim 11, wherein the first offset is a frame-level offset configured in units of frames, and the second offset is a slot-level offset configured in units of slots or a symbol-level offset configured in units of symbols.

13. The method of claim 11, wherein based on a configuration of a plurality of LOs associated with the PO, the LO configuration information includes the first offset for each of the plurality of LOs.

14. The method of claim 11, wherein the LO configuration information further includes information indicating a number of beams used for LP-WUS transmission and information indicating a number of LP-WUS monitoring occasions (MOs) for each of the beams, the LO includes the LP-WUS MOs, and positions of the LP-WUS MOs within the LO are determined based on the number of beams and the number of LP-WUS MOs.

15. The method of claim 11, further comprising transmitting: paging to the terminal in one or more POs mapped to the LO.

16. The method of claim 11, wherein the LP-WUS indicates one or more terminal subgroups that perform a monitoring operation for reception of paging in one or more POs mapped to the LO, and each of the one or more terminal subgroups includes one or more terminals.

17. The method of claim 16, wherein the LP-WUS supports up to 32 codepoints to indicate the one or more terminal subgroups.

18. The method of claim 16, wherein based on the LO and the PO having a 1-to-1 mapping relation, the LP-WUS indicates up to 31 terminal subgroups for one PO or an entire set of terminal subgroups for the one PO.

19. The method of claim 16, wherein based on the LO and the PO having a 1-to-2 mapping relation, the LP-WUS indicates up to 15 terminal subgroups for each of two POs or an entire set of terminal subgroups for each of the two POs.

20. The method of claim 16, wherein based on the LO and the PO having a 1-to-4 mapping relation, the LP-WUS indicates up to 7 terminal subgroups for each of four POs or an entire set of terminal subgroups for each of the four POs.
